(19) United States
(12) Patent Application Publication
(10) Pub. No.: US 2025/0301398 A1
(43) Pub. Date: Sep. 25, 2025

(54) HETEROMODAL TWO-PHASE RF SENSING

(71) Applicant: QUALCOMM Incorporated, San Diego, CA (US)

(72) Inventors: Weimin DUAN, San Diego, CA (US); Shijun WU, San Diego, CA (US); Kangqi LIU, San Diego, CA (US)

(21) Appl. No.: 18/610,954

(22) Filed: Mar. 20, 2024

(51) Int. Cl. H04W 48/16; H04L 5/00; H04W 48/12

(52) U.S. Cl. CPC H04W 48/16; H04L 5/0048; H04W 48/12

(57) ABSTRACT

Disclosed are techniques for wireless sensing. In an aspect, a user equipment (UE) or the UE and a wireless network structure (WNS) may perform a first radio frequency (RF) sensing operation using a first sensing mode. Based on the results of the first RF sensing operation, the UE and WNS may perform a second RF sensing operation using a second sensing mode different from the first sensing mode. At least one of the first sensing mode or the second sensing mode comprises a UE-based monostatic sensing mode, a UE-to-WNS bistatic sensing mode, or a WNS-to-UE bistatic sensing mode.

### TECHNICAL FIELD

Aspects of the disclosure relate generally to wireless technologies and more particularly to RF sensing

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing and other technical enhancements. These enhancements, including enhancement to RF sensing, as well as the use of higher frequency bands, advances in PRS processes and technology, and high-density deployments for 5G, enable highly accurate 5G-based sensing.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless sensing performed by a user equipment (UE) includes performing a first radio frequency (RF) sensing operation using a first sensing mode; determining, based on a result of the first RF sensing operation, that a second RF sensing operation should be performed using a second sensing mode different from the first sensing mode; and performing the second RF sensing operation using the second sensing mode, wherein at least one of the first RF sensing operation or the second RF sensing operation involves a wireless network structure (WNS).

In an aspect, a method of wireless sensing performed by a WNS includes performing a first RF sensing operation using a first sensing mode; determining, based on a result of the first RF sensing operation, that a second RF sensing operation should be performed using a second sensing mode different from the first sensing mode; and performing a second RF sensing operation using a second sensing mode different from the first sensing mode, wherein at least one of the first sensing mode and the second sensing mode involves a UE.

In an aspect, a UE includes one or more memories; one or more transceivers; and one or more processors communicatively coupled to the one or more memories and the one or more transceivers, the one or more processors, either alone or in combination, configured to: perform a first RF sensing operation using a first sensing mode; determine, based on a result of the first RF sensing operation, that a second RF sensing operation should be performed using a second sensing mode different from the first sensing mode; and perform the second RF sensing operation using the second sensing mode, wherein at least one of the first RF sensing operation or the second RF sensing operation involves a WNS, and wherein at least one of the first sensing mode or the second sensing mode comprises a UE-based monostatic sensing mode, a UE-to-WNS bistatic sensing mode, or a WNS-to-UE bistatic sensing mode.

In an aspect, a WNS includes one or more memories; one or more transceivers; and one or more processors communicatively coupled to the one or more memories and the one or more transceivers, the one or more processors, either alone or in combination, configured to: perform a first RF sensing operation using a first sensing mode; determine, based on a result of the first RF sensing operation, that a second RF sensing operation should be performed using a second sensing mode different from the first sensing mode; and perform a second RF sensing operation using a second sensing mode different from the first sensing mode, wherein at least one of the first sensing mode and the second sensing mode involves a UE, and wherein at least one of the first sensing mode or the second sensing mode comprises a UE-based monostatic sensing mode, a UE-to-WNS bistatic sensing mode, or a WNS-to-UE bistatic sensing mode.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures (WNSs), according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 is a diagram illustrating various uplink channels within an example uplink slot, according to aspects of the disclosure.

FIGS. 7A and 7B illustrate different types of wireless sensing, according to aspects of the disclosure.

FIGS. 8A to 8F illustrate various example monostatic and bistatic sensing use cases, according to aspects of the disclosure.

FIG. 9 illustrates an example call flow for a New Radio (NR)-based sensing procedure in which the network configures the sensing parameters, according to aspects of the disclosure.

FIGS. 10-13 are flow charts illustrating methods for heteromodal two-phase RF sensing according to aspects of the disclosure.

FIG. 14 is a flowchart of an example process, performed by a UE, associated with heteromodal two-phase RF sensing, according to aspects of the disclosure.

FIG. 15 is a flowchart of an example process, performed by a WNS, associated with heteromodal two-phase RF sensing, according to aspects of the disclosure.

FIGS. 16-18 are signaling and event diagrams illustrating portions of example processes associated with heteromodal two-phase RF sensing, according to aspects of the disclosure.

### DETAILED DESCRIPTION

Disclosed are techniques for wireless sensing. In an aspect, a user equipment (UE) or the UE and a wireless network structure (WNS) may perform a first radio frequency (RF) sensing operation using a first sensing mode. Based on the results of the first RF sensing operation, the UE and WNS may perform a second RF sensing operation using a second sensing mode different from the first sensing mode. At least one of the first sensing mode or the second sensing mode comprises a UE-based monostatic sensing mode, a UE-to-WNS bistatic sensing mode, or a WNS-to-UE bistatic sensing mode.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to joint communication and sensing. Some aspects more specifically relate to heteromodal RF sensing, wherein the first RF sensing operation uses a first sensing mode and the second RF sensing operation uses a second sensing mode different from the first sensing mode. In some examples, the first RF sensing operation uses a UE-based monostatic sensing mode and the second RF sensing operation uses either a UE-to-gNB or gNB-to-UE bistatic sensing mode.

Particular aspects of the subject matter described in this disclosure can be implemented to realize one or more of the following potential advantages. In some examples, using different sensing modes in each phase of the two-phase sensing provides not only the general advantages of two-phase sensing but also the benefits of the specific advantages of each of the two different sensing modes.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

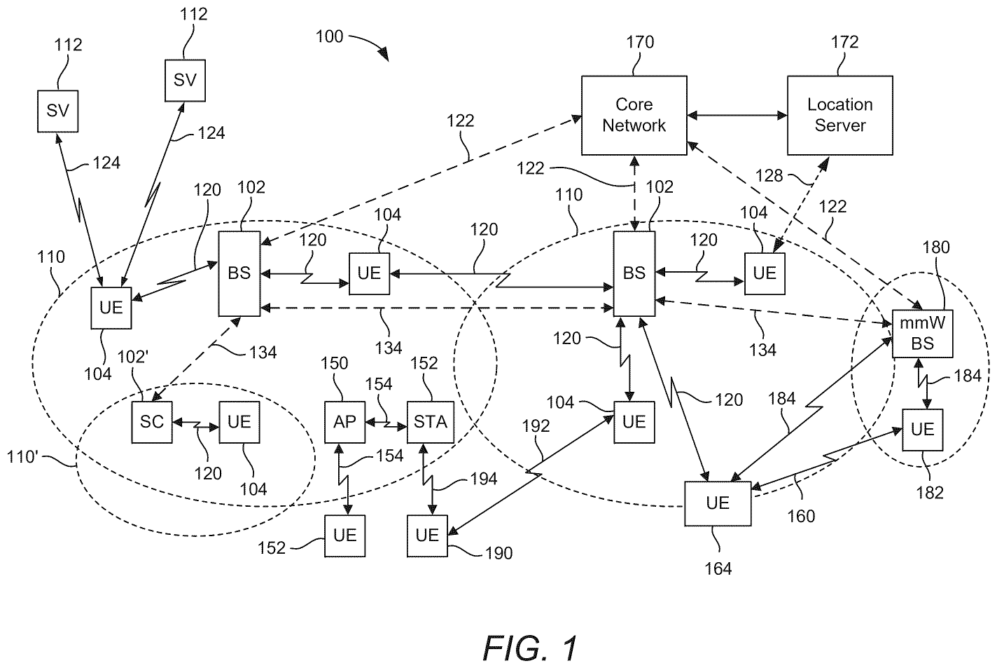

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for transmitting an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

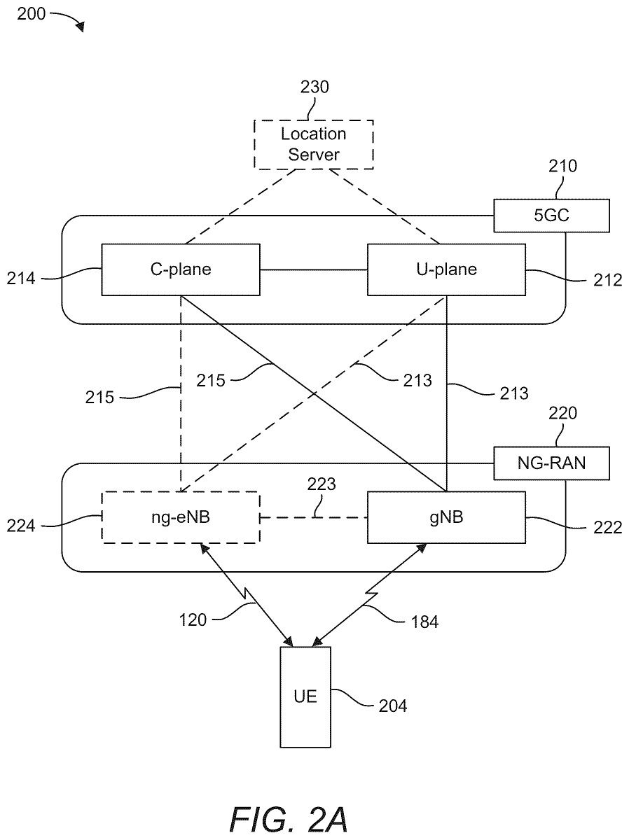

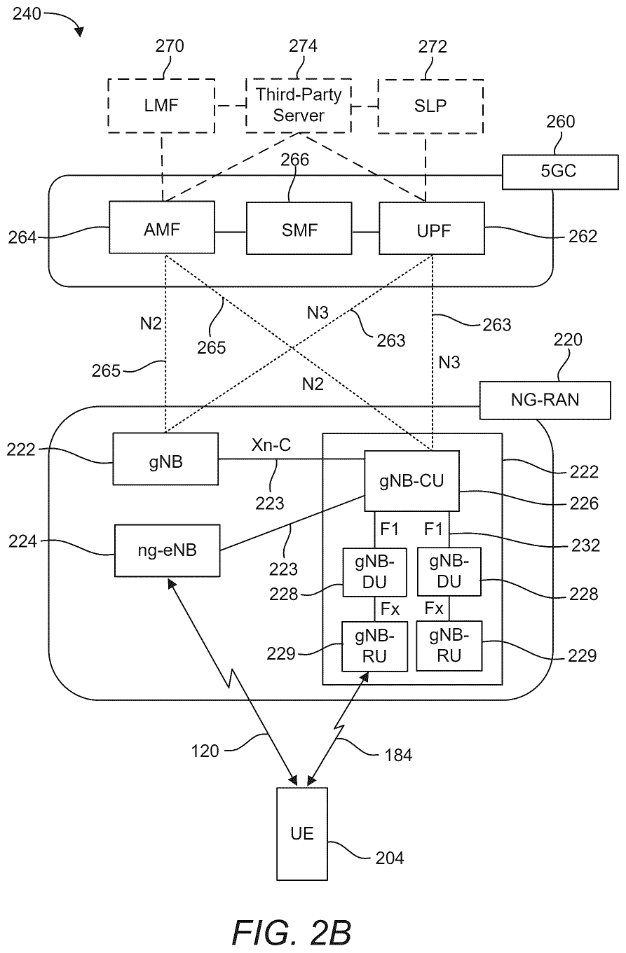

FIG. 2A illustrates an example wireless network structure (WNS) 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

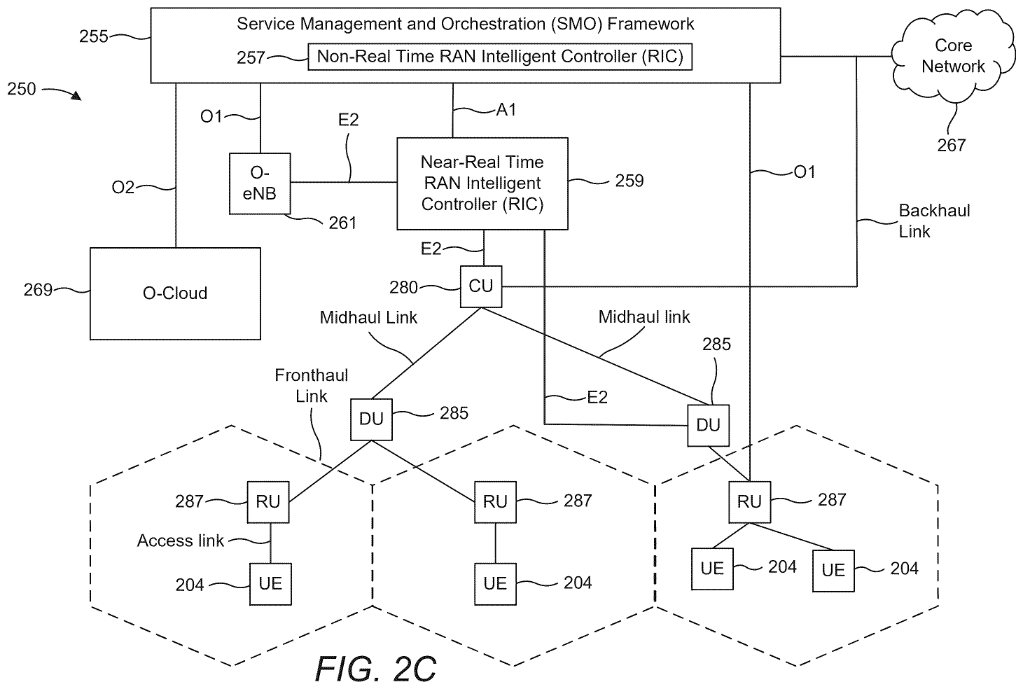

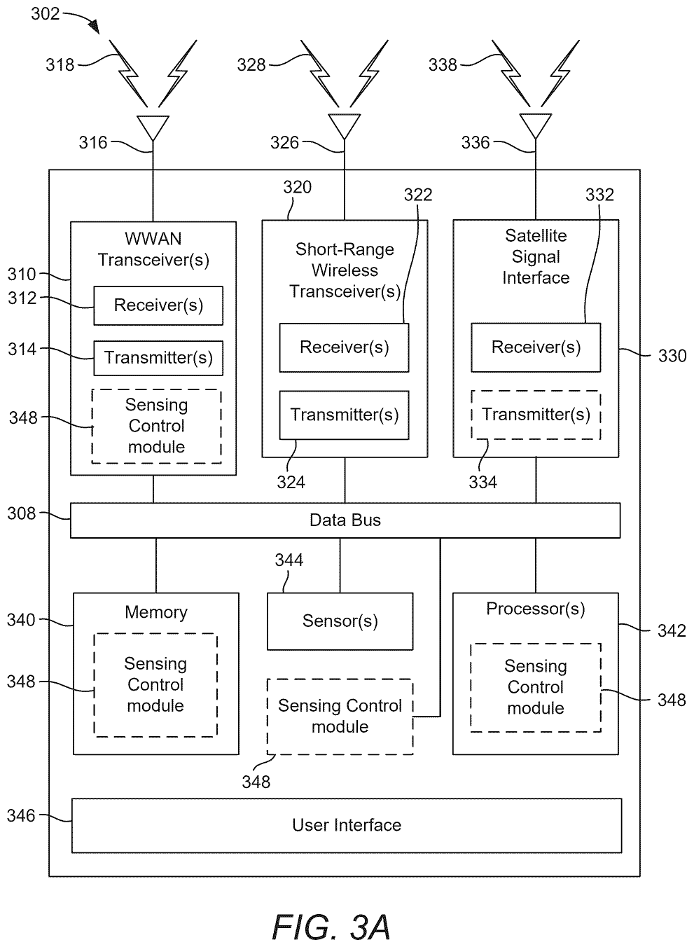

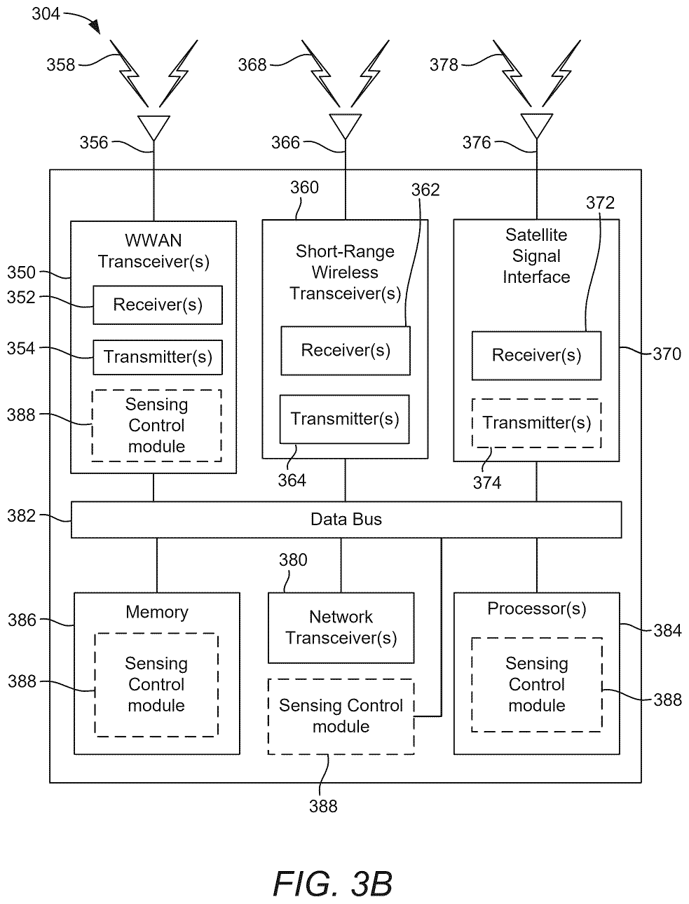

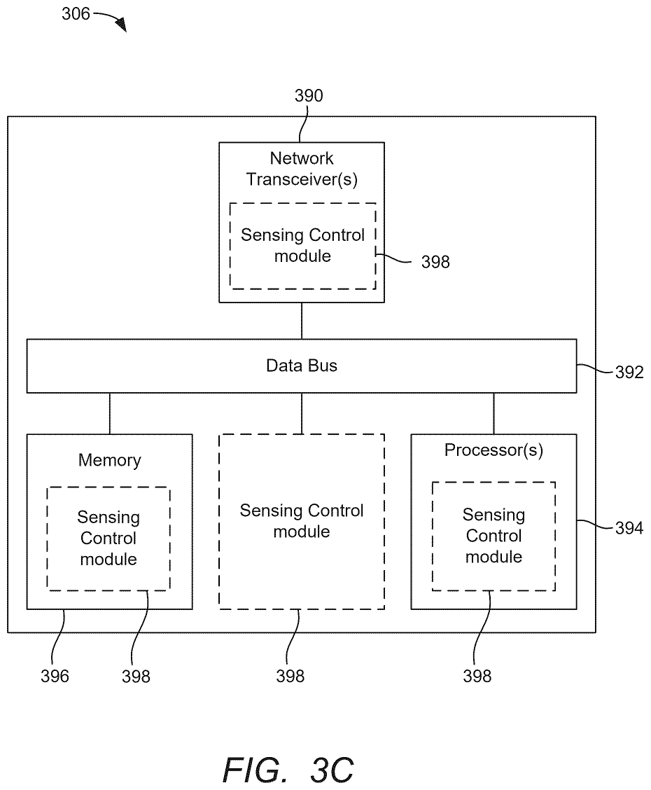

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receiver(s) 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receiver(s) 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include sensing control module 348, 388, and 398, respectively. The sensing control module 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the sensing control module 348, 388, and 398 may be external to the processors 342, 384, and 394 (e.g., part of a modem processing system, integrated with another processing system, etc.). Alternatively, the sensing control module 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the sensing control module 348, which may be, for example, part of the one or more WWAN transceivers 310, the memory 340, the one or more processors 342, or any combination thereof, or may be a standalone component. FIG. 3B illustrates possible locations of the sensing control module 388, which may be, for example, part of the one or more WWAN transceivers 350, the memory 386, the one or more processors 384, or any combination thereof, or may be a standalone component. FIG. 3C illustrates possible locations of the sensing control module 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the sensing control module 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

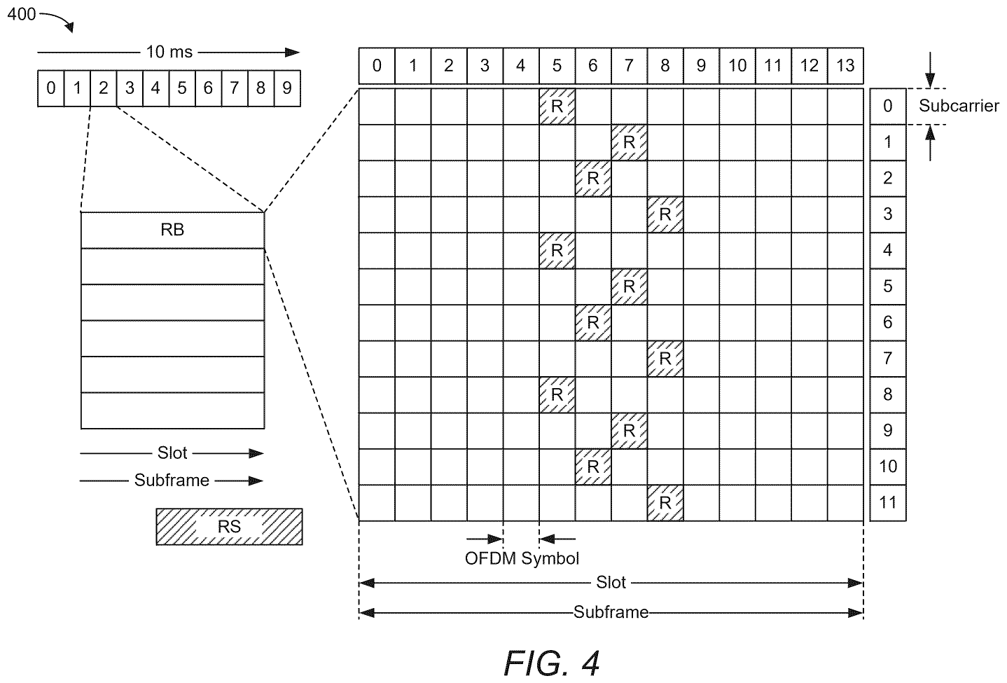

FIG. 4 is a diagram illustrating an example frame structure, according to aspects of the disclosure. Various frame structures may be used to support downlink and uplink transmissions between network nodes (e.g., base stations and UEs). The frame structure may be a downlink or uplink frame structure. Other wireless communications technologies may have different frame structures and/or different channels. LTE, and in some cases NR, utilizes orthogonal frequency-division multiplexing (OFDM) on the downlink and single-carrier frequency division multiplexing (SC-FDM) on the uplink.

Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

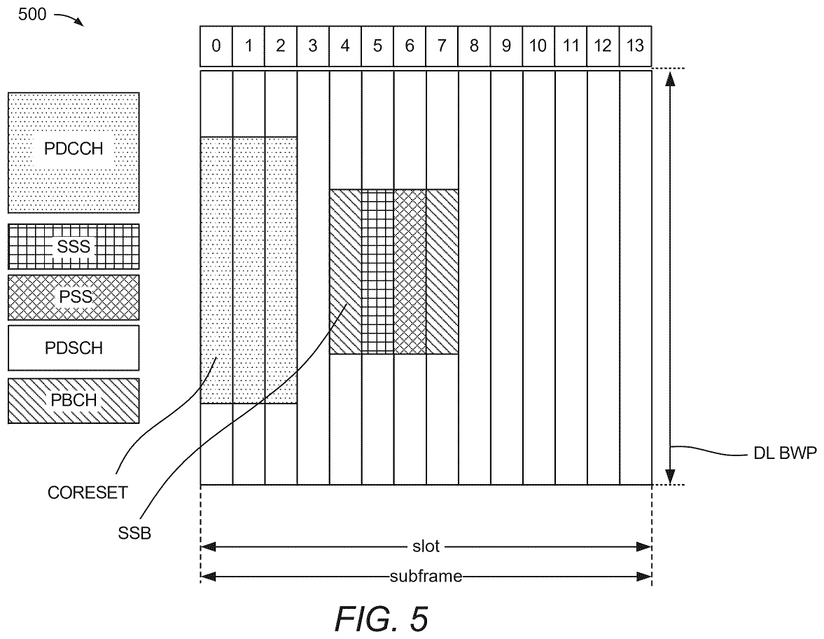

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

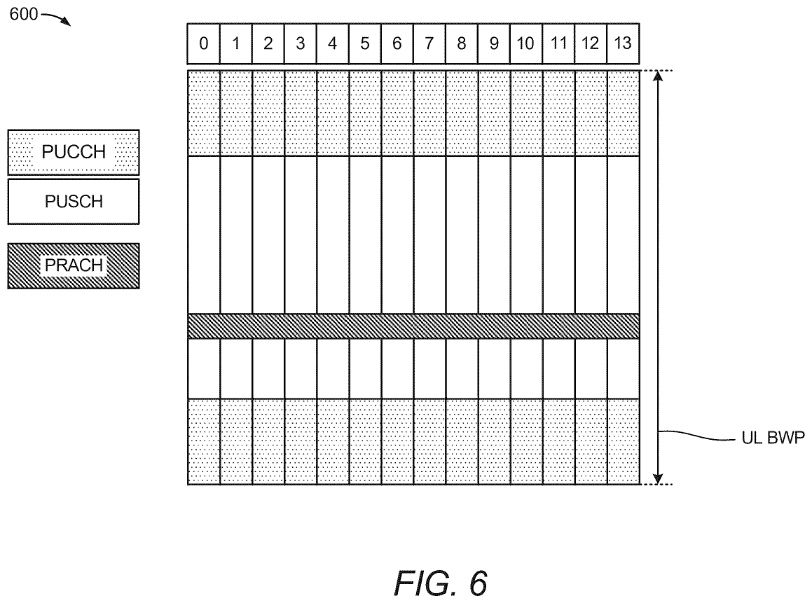

FIG. 6 is a diagram 600 illustrating various uplink channels within an example uplink slot. In FIG. 6, time is represented horizontally (on the X axis) with time increasing from left to right, while frequency is represented vertically (on the Y axis) with frequency increasing (or decreasing) from bottom to top. In the example of FIG. 6, a numerology of 15 kHz is used. Thus, in the time domain, the illustrated slot is one millisecond (ms) in length, divided into 14 symbols.

A random-access channel (RACH), also referred to as a physical random-access channel (PRACH), may be within one or more slots within a frame based on the PRACH configuration. The PRACH may include six consecutive RB pairs within a slot. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests, CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

Wireless communication systems exchange information between two or more cooperative entities. Wireless sensing systems, such as radar, for example, use radio frequency signals to probe and detect passive or uncooperative targets, and infer useful information from the target echoes. In monostatic sensing, the same entity sends the probing signals and receives the echoes from the probing signals. In bistatic or multi-static sensing, the entity that sends the probing signals and the entity that receives the echoes from the probing signals are not the same.

Joint communication and sensing (JCAS) systems perform both wireless communication and wireless sensing, sometimes simultaneously. For example, a JCAS system may perform both wireless communication and remote radar sensing using the same RF circuitry, providing a cost-efficient deployment for both radar and communication systems. This usually involves allocating time, frequency, and spatial resources to support the two purposes (communication and sensing) in the integrated system. 5G-based wireless sensing may be further characterized based on which entity is receiving the echoes from the sensing signals: base station (BS)-based sensing or user equipment (UE)-based sensing.

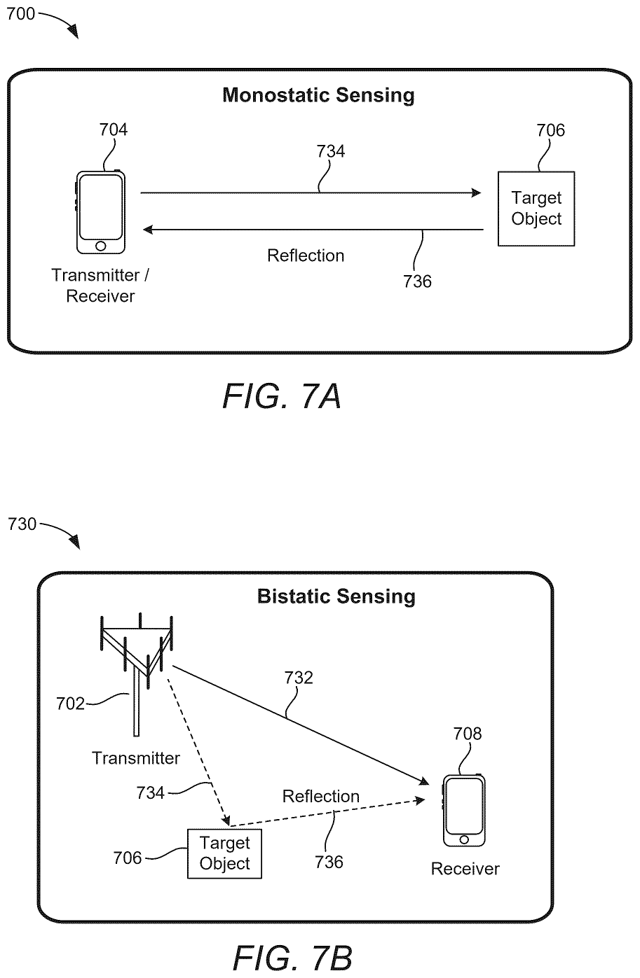

FIGS. 7A and 7B illustrate different types of wireless sensing, according to aspects of the disclosure. wireless communication signals (e.g., radio frequency (RF) signals configured to carry orthogonal frequency division multiplexing (OFDM) symbols in accordance with a wireless communications standard, such as LTE, NR, etc.) transmitted between a UE and a base station can be used for environment sensing (also referred to as “RF sensing” or “radar”). Using wireless communication signals for environment sensing can be regarded as consumer-level radar with advanced detection capabilities that enable, among other things, touchless/device-free interaction with a device/system. The wireless communication signals may be cellular communication signals, such as LTE or NR signals, WLAN signals, such as Wi-Fi signals, etc. As a particular example, the wireless communication signals may be an OFDM waveform as utilized in LTE and NR. High-frequency communication signals, such as millimeter wave (mmW) RF signals, are especially beneficial to use as sensing signals because the higher frequency provides, at least, more accurate range (distance) detection.

Possible use cases of RF sensing include health monitoring use cases, such as heartbeat detection, respiration rate monitoring, and the like, gesture recognition use cases, such as human activity recognition, keystroke detection, sign language recognition, and the like, contextual information acquisition use cases, such as location detection/tracking, direction finding, range estimation, and the like, and automotive sensing use cases, such as smart cruise control, collision avoidance, and the like.

There are different types of sensing, including monostatic sensing (also referred to as “active sensing”) and bistatic sensing (also referred to as “passive sensing”). FIGS. 7A and 7B illustrate these different types of sensing. Specifically, FIG. 7A is a diagram 700 illustrating a monostatic sensing scenario and FIG. 7B is a diagram 730 illustrating a bistatic sensing scenario.

In FIG. 7A, the transmitter (Tx) and receiver (Rx) are co-located in the same sensing device 704 (e.g., a UE). The sensing device 704 transmits one or more RF sensing signals 734 (e.g., uplink or sidelink positioning reference signals (PRS) where the sensing device 704 is a UE), and some of the RF sensing signals 734 reflect off a target object 706 (e.g., an unmanned aerial vehicle (UAV)). The sensing device 704 can measure various properties (e.g., times of arrival (ToAs), angles of arrival (AoAs), phase shift, etc.) of the reflections 736 of the RF sensing signals 734 to determine characteristics of the target object 706 (e.g., size, shape, speed, motion state, etc.).

In FIG. 7B, the transmitter (Tx) and receiver (Rx) are not co-located, that is, they are separate devices (e.g., a UE and a base station). Note that while FIG. 7B illustrates using a downlink RF signal as the RF sensing signal 732, uplink RF signals or sidelink RF signals can also be used as RF sensing signals 732. In a downlink scenario, as shown, the transmitter device 702 is a base station (e.g., a gNB) and the receiver device 708 is a UE (e.g., a mobile phone, a V2X-capable vehicle, a roadside unit (RSU), etc.), whereas in an uplink scenario, the transmitter device 702 is a UE and the receiver device 708 is a base station. Where the transmitter device 702 is a base station and the receiver device 708 a UE, the sensing is referred to as UE-assisted sensing. In UE-assisted sensing, the position of receiver device 708 should be known by the network (e.g., by GPS or other UE positioning method).

Referring to FIG. 7B in greater detail, the transmitter device 702 transmits RF sensing signals 732 and 734 (e.g., positioning reference signals (PRS)) to the receiver device 708, but some of the RF sensing signals 734 reflect off a target object 706. The receiver device 708 (also referred to as the “sensing device”) can measure the times of arrival (ToAs) of the RF sensing signals 732 received directly from the transmitter device 702 and the ToAs of the reflections 736 of the RF sensing signals 734 reflected from the target object 706. More specifically, as described above, a transmitter device (e.g., a base station) may transmit a single RF signal or multiple RF signals to a receiver device (e.g., a UE). However, the receiver may receive multiple RF signals corresponding to each transmitted RF signal due to the propagation characteristics of RF signals through multipath channels. Each path may be associated with a cluster of one or more channel taps. Generally, the time at which the receiver detects the first cluster of channel taps is considered the ToA of the RF signal on the line-of-site (LOS) path (i.e., the shortest path between the transmitter and the receiver). Later clusters of channel taps are considered to have reflected off objects between the transmitter and the receiver and therefore to have followed non-LOS (NLOS) paths between the transmitter and the receiver.

Thus, referring back to FIG. 7B, the RF sensing signals 732 followed the LOS path between the transmitter device 702 and the receiver device 708, and the RF sensing signals 734 followed an NLOS path between the transmitter device 702 and the receiver device 708 due to reflecting off the target object 706. The transmitter device 702 may have transmitted multiple RF sensing signals 732, 734, some of which followed the LOS path and others of which followed the NLOS path. Alternatively, the transmitter device 702 may have transmitted a single RF sensing signal in a broad enough beam that a portion of the RF sensing signal followed the LOS path (RF sensing signal 732) and a portion of the RF sensing signal followed the NLOS path (RF sensing signal 734). Based on the ToA of the LOS path, the ToA of the NLOS path, and the speed of light, the receiver device 708 can determine the distance to the target object(s). For example, the receiver device 708 can calculate the distance to the target object as the difference between the ToA of the LOS path and the ToA of the NLOS path multiplied by the speed of light. In addition, if the receiver device 708 is capable of receive beamforming, the receiver device 708 may be able to determine the general direction to a target object 706 as the direction (angle) of the receive beam on which the RF sensing signal following the NLOS path was received. That is, the receiver device 708 may determine the direction to the target object 706 as the AoA of the RF sensing signal, which is the angle of the receive beam used to receive the RF sensing signal. The receiver device 708 may then optionally report this information to the transmitter device 702, its serving base station, an application server associated with the core network, an external client, a third-party application, or some other sensing entity. Alternatively, the receiver device 708 may report the ToA measurements to the transmitter device 702, or other sensing entity (e.g., if the receiver device 708 does not have the processing capability to perform the calculations itself), and the transmitter device 702 may determine the distance and, optionally, the direction to the target object 706.

Note that if the RF sensing signals are uplink RF signals transmitted by a UE to a base station, the base station would perform object detection based on the uplink RF signals just like the UE does based on the downlink RF signals. Like conventional radar, wireless communication-based sensing signals can be used to estimate the range (distance), velocity (Doppler), and angle (AoA) of a target object. However, the performance (e.g., resolution and maximum values of range, velocity, and angle) may depend on the design of the reference signal.

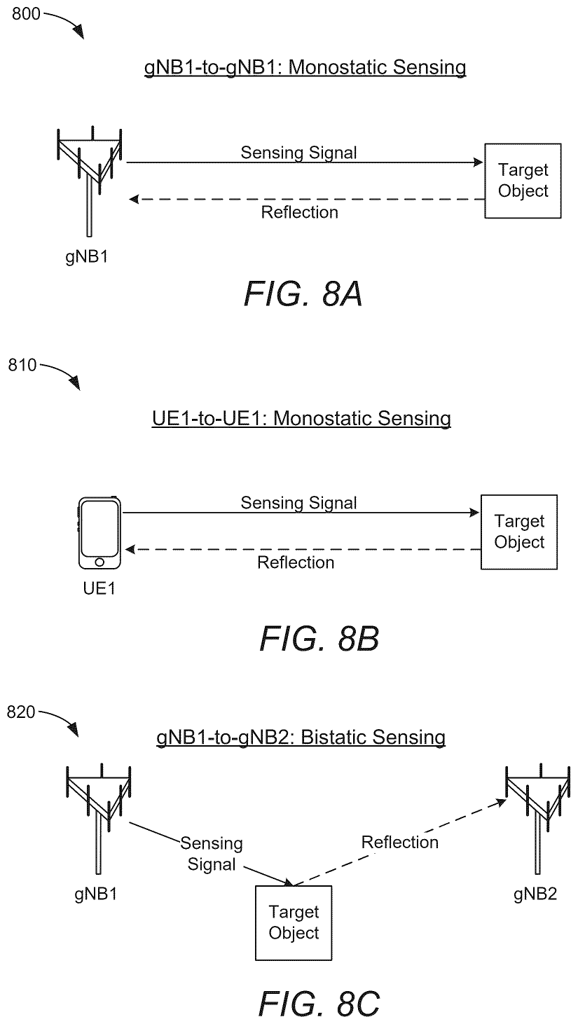

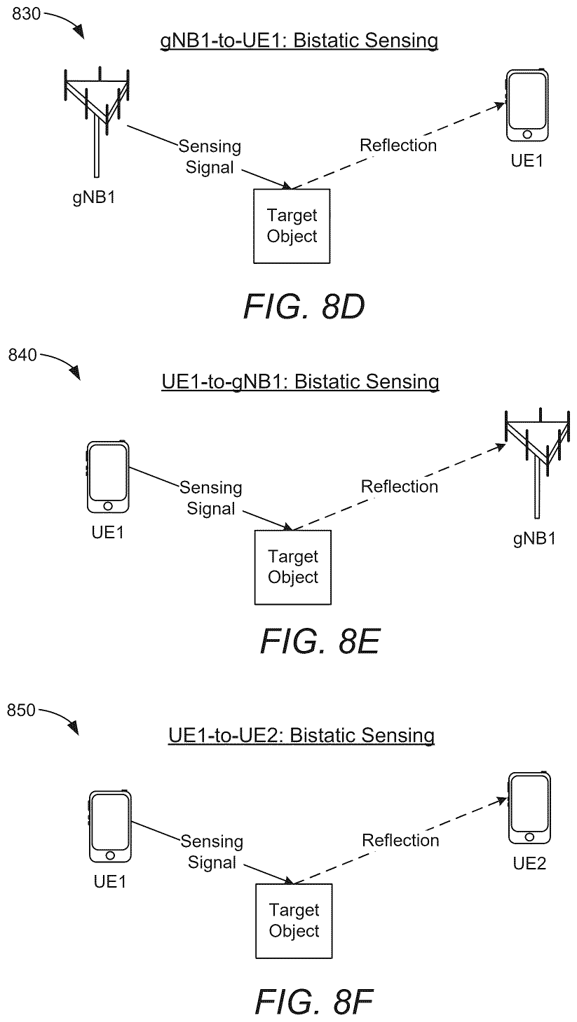

FIGS. 8A to 8F illustrate various example monostatic and bistatic sensing use cases, according to aspects of the disclosure. In FIG. 8A, a gNB1-to-gNB1 monostatic sensing use case 800 is depicted. In FIG. 8B, a UE1-to-UE1 monostatic sensing use case 810 is depicted. In FIG. 8C, a gNB1-to-gNB2 bistatic sensing use case 820 is depicted. In FIG. 8D, a gNB1-to-UE1 bistatic sensing use case 830 is depicted. In FIG. 8E, a UE1-to-gNB1 bistatic sensing use case 840 is depicted. In FIG. 8F, a UE1-to-UE2 bistatic sensing use case 850 is depicted.

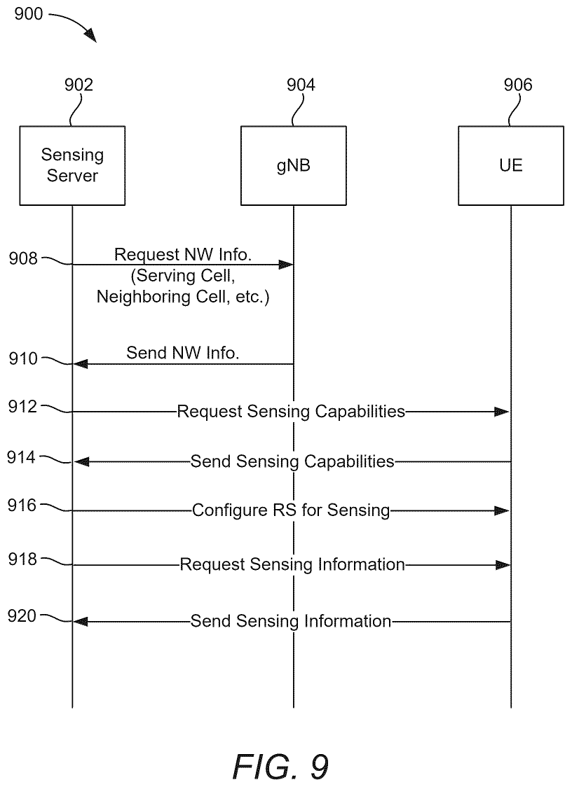

FIG. 9 illustrates an example call flow 900 for an NR-based sensing procedure (e.g., a bistatic sensing procedure) in which the network configures the sensing parameters, according to aspects of the disclosure. Although FIG. 9 illustrates a network-coordinated sensing procedure, the sensing procedure could be coordinated over sidelink channels. FIG. 9 illustrates an interaction between a sensing server 902, a gNB 904, and a UE 906.

At stage 908, the sensing server 902 (e.g., inside or outside the core network) sends a request for network (NW) information to the gNB 904 (e.g., the serving gNB of the UE 906). The request may be for a list of the UE's serving cell and any neighboring cells. At stage 910, the gNB 904 sends the requested information to the sensing server 902. At stage 912, the sensing server 902 sends a request for sensing capabilities to the UE 906. At stage 914, the UE 906 provides its sensing capabilities to the sensing server 90.

At stage 916, the sensing server 902 sends a configuration to the UE 906 indicating one or more reference signal (RS) resources that will be transmitted for sensing. The reference signal resources may be transmitted by the serving and/or neighboring cells identified at stage 910. In some cases, the NR-based sensing procedure illustrated in FIG. 9 may be a sensing-only procedure or a joint communication and sensing (JCS) procedure. In the case of a sensing-only procedure, the reference signal resources may be reference signal resources specifically configured for sensing purposes. In the case of a JCS procedure, the reference signal resources may be reference signal resources for communication that can also be used for sensing purposes. Alternatively, the reference signal resources for sensing may be multiplexed (e.g., time-division multiplexed) with reference signal resources for communication. For example, the reference signal resources for communication may be an orthogonal frequency division multiplexing (OFDM) waveform, while the reference signal resources for sensing may be a frequency modulation continuous wave (FMCW) waveform.

At stage 918, the sensing server 902 sends a request for sensing information to the UE 906. The UE 906 then measures the transmitted reference signals and, at stage 920, sends the measurements, or any sensing results determined from the measurements, to the sensing server 902.

In an aspect, the communication between the UE 906 and the sensing server 902 may be via the LTE positioning protocol (LPP). The communication between the sensing server 902 and the gNB 904 may be via NR positioning protocol type A (NRPPa).

In some aspects, a communication system can support multiple sensing modes, each with its own advantages and disadvantages. For example, UE monostatic sensing is more suitable for use cases where user device is consumer of sensing results, e.g., gesture control on smartphone, but this sensing mode requires full-duplex capability at the UE. In BS monostatic sensing, an individual BS performs sensing, e.g., which can be a network implementation without impact to the UE, but full duplex at the BS is required (which can be less challenging than at a UE due to the larger form factor/antenna array size of a BS compared to a UE). In BS-to-UE bistatic sensing, the UE performs sensing based on signal sent by a BS or another UE, and the sensing can reuse some of the DL communication protocol and can be implemented without requiring full-duplex capability by the UE, but Tx and Rx synchronization is required. In UE-to-BS bistatic sensing, the BS performs sensing based on UL signals sent by the UE(s) and can reuse some of the UL communication protocol. In BS-to-BS bistatic sensing, the BS performs sensing based on sensing signals sent by another BS, without impact to the UEs, but this requires a new functionality to be added to the network for environment sensing. In UE-to-UE bistatic sensing, sensing is performed at one UE based on a sensing signal sent by another UE, similar to sidelink communication, and V2X can be a use case for this sensing mode. From the above, it can be seen that standardization efforts and UE implementation complexity are different for different sensing modes.

An additional challenge involves determining which of the different sensing modes to use, since each mode has advantages and disadvantages. For example, sensing resource overhead in a JCAS system can be high: sensing usually requires larger bandwidth and long duration signal transmission to meet sensing requirements (range, processing gain, etc.). Moreover, sensing is different from positioning, where the target is generally cooperative and connected. Sensing a passive and/or uncooperative target can be ‘blind’ in the sense that it may be unknown whether the passive object even exists prior to the sensing operation, and this means that sensing can incur unnecessary high overhead in the communication system.

One approach to address this problem is to use two-phase sensing. In the first phase, the sensing operation can be based on less intense sensing signal transmission (e.g., smaller bandwidth/resource occupancy, larger beam width, etc.). The main goal of the first phase of sensing may be to detect the presence of a target of interest, and thus the first phase of sensing may also be referred to as coarse sensing or the scan phase of sensing. In the second phase, the sensing operation can be based on more intense but also more purposeful sensing signal transmissions (e.g., larger bandwidth, smaller beam width, more frequent transmissions, etc.), based on sensing results from the first phase (e.g., second phase may not be performed if no target has been detected in the first phase sensing). The main goal of the second phase sensing may be to estimate sensing-related metrics that can meet some sensing requirements, e.g., target distance, size, shape, etc., and thus the second phase of sensing may also be referred to as fine sensing or the tracking phase of sensing. Conventional two-phase sensing operations uses the same sensing mode for each phase, but with each phase using different bandwidth or beam width.

However, two-phase sensing with different sensing modes in the two phases may provide unique advantages. For example, employing different sensing modes in each phase has the potential to take advantage of the different benefits associated with each of the different sensing modes and overcome the disadvantages associated with those different sensing modes. Other advantages may include fewer standardization efforts, less report/feedback overhead, etc., which may further improve two-phase sensing performance compared to two-phase sensing that uses the same sensing mode for each phase.

Accordingly, presented herein are techniques for heteromodal two-phase RF sensing, according to aspects of the disclosure. The following examples are illustrative and not limiting.

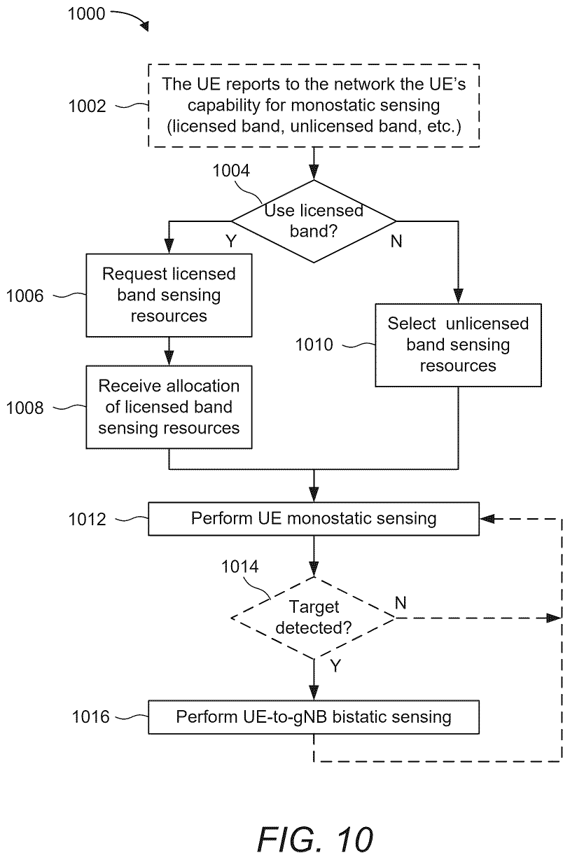

FIG. 10 is a flow chart illustrating a method 1000 for heteromodal two-phase RF sensing according to aspects of the disclosure. In the example illustrated in FIG. 10, the first phase may be UE monostatic sensing and the second phase may be bistatic sensing involving the UE and a gNB. In the first phase, for example, the sensing may be performed by the UE to identify potential targets (and thus may be referred to as a “scan phase”), and in the second phase, the bistatic sensing can be bistatic UE-to-gNB sensing (wherein the sensing is performed at the gNB), which may have greater processing capability, resolution, and/or accuracy than the UE (and thus the second phase sensing may be referred to as a “targeting phase”). In some aspects, the resources allocated for the second phase sensing signal(s) may be selected based on sensing results from the first phase, which the UE may report to the gNB.

In the example shown in FIG. 10, the method 1000 includes, at optional block 1002, the UE reports to the network the UE's capability for monostatic sensing. In some aspects, this report indicates which bands the UE is capable of using for sensing purposes, e.g., whether the UE can perform sensing on licensed bands only, on either licensed or unlicensed bands, on both licensed and unlicensed band simultaneous, on unlicensed bands only, or other combinations of capabilities. In some aspects, the UE may be required to report to the network the UE's capability to perform sensing in an unlicensed band, e.g., so that the network knows that it has the option of not allocating licensed spectrum resources to the UE for the UE's scan phase since the UE can use unlicensed spectrum resources instead. Conversely, if the network knows that the UE does not have the capability to perform sensing in an unlicensed band, the network knows that it needs to allocate licensed spectrum resources to the UE for the UE's scan phase. At block 1004, based on the UE's capability, the UE or the network may decide whether the UE should use a licensed band, an unlicensed band, or both. In some aspects, if a UE does not have the capability for performing monostatic sensing in an unlicensed band, the first phase may be performed using a configured resource pool in a licensed band. In some aspects, if a UE does not have the capability for performing monostatic sensing in an unlicensed band, the first phase sensing may be performed using the second sensing mode as the second phase.

In some aspects, the UE may perform monostatic sensing over a licensed band. As shown in FIG. 10, at block 1006, the UE may request licensed band sensing resources from the network, and at block 1008, the UE may be allocated licensed band sensing resources. In some aspects, the network configures a resource pool for the UE that is performing monostatic sensing. In some aspects, the UE selects one or more resources in the resource pool for transmission of sensing signals to perform monostatic sensing. In some aspects, the resource selection may be subject to a constraint configured by the network. For example, the network may impose a duty cycle constraint to ensure that a single UE's sensing signal transmission won't exceed an occupancy limit. In some aspects, the UE may be allowed to select resources while in the radio resource control RRC IDLE state and/or the RRC INACTIVE state.

In some aspects, the UE may perform monostatic sensing over an unlicensed band. As shown in FIG. 10, at block 1010, the UE can independently decide the specific parameters and details of the first phase monostatic sensing operation, such as the waveform, duty cycle, etc., and select its own unlicensed band sensing resources. An advantage of this approach is that the first phase can be UE-implemented and/or controlled (e.g., if the UE uses the unlicensed band). In some aspects, the UE may be allowed to switch from monostatic sensing in an unlicensed band to sensing in a licensed band. For example, if the UE attempts to perform monostatic sensing in an unlicensed band but experiences high interference in the unlicensed band, the UE may request to switch to a monostatic or bistatic sensing mode in a licensed band instead.

As further shown in FIG. 10, the method 1000 includes, at block 1012, performing monostatic sensing by the UE. If a target is detected (optional block 1014), then UE-to-gNB bistatic sensing is performed as the second phase of sensing (block 1016). In some aspects, the two-phase sensing process may be repeated. In some aspects, optional block 1014 is skipped and the second phase is always performed. In some aspects, network overhead for the second phase is incurred only when a potential target has been detected during the first phase. In the example shown in FIG. 10, at optional block 1014, it is determined whether a target has been detected during the monostatic scanning phase, and if not, the second phase is skipped.

In some aspects, the first phase monostatic sensing may identify at least one or more of beam directions pertaining to one or more potential targets, distance estimate to one or more potential targets, or estimated speeds of one or more potential targets. In some aspects, the second phase bistatic sensing may be triggered if one or more potential targets were been detected in the first phase.

In some aspects, when the second phase sensing is triggered, the UE may send to the gNB or to a sensing server a request for UL resources to be used for second phase sensing signal transmission. In some aspects, the UE may report one or more of the following to the network for requesting second phase sensing resources: the number of beams (or number of resources) for UL sensing signal transmission—this may be dependent on first phase sensing results as well as its beamforming capability (number of antenna elements, beam width, etc.); a frequency comb configuration for second phase sensing signal transmission—this may be determined based on target range identified in the first phase (smaller RE interval in frequency for sensing RS is needed if target is farther); a bandwidth of sensing signal transmission for second phase—this may be determined based on sensing requirement; or a sensing signal time spacing (or time comb)—this may be needed if velocity estimation for the target is needed. In some aspects, the requested configuration may be the same for the beams (or resources) the UE is requesting (e.g., comb configuration based on the farthest target, time spacing configuration based on the fastest target). In some aspects, the requested configuration may be per beam (or per resource), i.e., different time spacing and/or frequency comb configuration may be requested for different beams to improve sensing resource efficiency.

In some aspects, when the UE performs monostatic sensing in an unlicensed band, the UE may report this as a capability to the network. In some aspects, for a UE without the capability of monostatic sensing in an unlicensed band (which may be a default scenario), the first phase sensing may be performed using the same sensing mode as that for the second phase (i.e., UE-to-gNB bistatic sensing). In some aspects, for a UE without the capability of monostatic sensing in an unlicensed band, the first phase may be performed using the configured resource pool in licensed band. In some aspects, a UE without the capability of monostatic sensing in an unlicensed band may be allowed to switch to a first phase sensing in a licensed spectrum. In some aspects, even if the UE has the capability of monostatic sensing in an unlicensed band, if the UE experiences high interference in the unlicensed band, the UE may request to switch to a sensing mode taking place in licensed band, like the default UE-to-gNB sensing in the first phase.

In some aspects, the UE may send to the network a request for second phase sensing resources. In some aspects, the per beam (or per resource) sensing signal configuration (e.g., per beam time- and/or frequency-comb) may be up to network configuration—i.e., the network can configure whether or not it is being used. In some aspects, the per beam (or per resource) sensing signal configuration may be a UE capability—the UE reports it to network (i.e., whether the UE can adjust its time- and/or frequency-comb in sensing RS transmission across beams/resources is a UE capability). In some aspects, the UE may determine whether to use per-beam configuration and indicate that to the network.

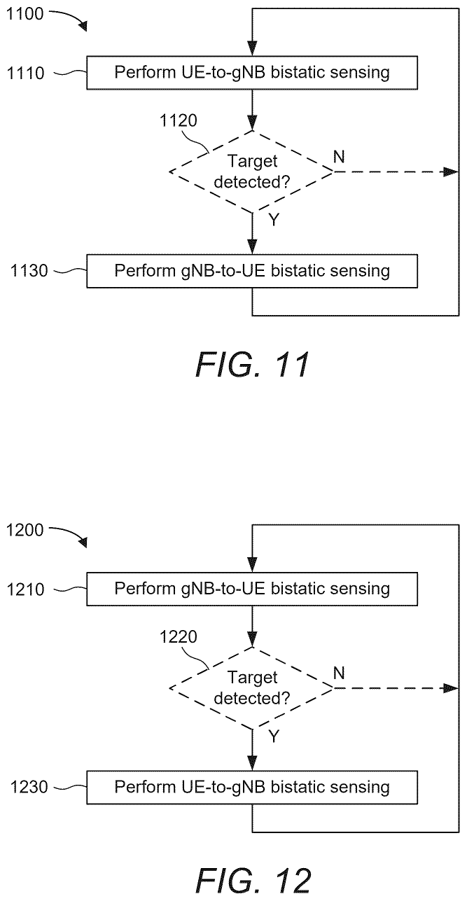

FIG. 11 is a flow chart illustrating a method 1100 for heteromodal two-phase RF sensing according to aspects of the disclosure. In the example illustrated in FIG. 11, the first phase may be UE-to-gNB bistatic sensing and the second phase may be gNB-to-UE bistatic sensing. In the first phase, for example, ‘coarse’ sensing is performed to identify potential targets as well as beam directions or other transmission configuration indications (TCI) associated with sensing the target. In the second phase, ‘fine’ sensing can be performed at the beam directions identified in the first phase. An advantage to this approach is that there is less feedback/report overhead for coupling the two phases. In the example shown in FIG. 11, at block 1110, a first phase UE-to-gNB bistatic sensing is performed. In some aspects, an optional step 1120 may determine whether or not a target has been detected; if so, at block 1130, the second phase gNB-to-UE bistatic sensing is performed, and if not, the second phase sensing step is skipped. Alternatively, the optional block 1120 is not performed, in which case the first phase sensing step at block 1110 is always followed by the second phase sensing step at block 1130.

Regarding the first phase UE-to-gNB bistatic sensing (block 1110), in some aspects, the network configures the UE for transmitting an uplink sensing signal, which is the first phase (or scan phase) sensing. In some aspects, the first phase sensing signal may cover broader field of view (FoV), e.g., broader beam and/or multiple beam directions/resources, but using less overhead per-beam/per-resource (e.g., smaller bandwidth, less duration, etc.).

In the example shown in FIG. 11, the network then performs sensing based on the UL sensing signal sent by the UE. In some aspects, this may include at least identifying beam(s) and/or resource(s) in the first phase sensing signal transmission that has potential target(s) for detection. In some aspects, this may also include determining the configuration for second phase sensing signal transmission, e.g., bandwidth, time duration, time- and/or frequency-comb, etc.

During the second phase sensing operation (block 1130), the network transmits the sensing signal to the UE. In some aspects, the network transmits the second phase sensing signal (block 1130) based on the results of the first phase sensing operation. In some aspects, the network indicates at least the following to the UE for performing second phase gNB-to-UE sensing: the index or indices of first phase sensing signal beam(s)/resource(s) that are relevant for second phase sensing signal receiving at the UE—this will imply beam directions that the UE will be using in second phase sensing signal receiving (QCL); a configuration for each of the second phase sensing beam/resource, if that is configurable. For example, during the first phase of sensing, a UE may send four uplink sensing beams in four resources, and the network may detect potential targets in the first and last of the four sensing beams/resources. In this example, the network may indicate to the UE that the network will transmit two downlink sensing beams, and the UE will receive the two downlink sensing beams using the same spatial filter as was used for transmitting the corresponding uplink beams in the first sensing phase.

FIG. 12 is a flow chart illustrating a method 1200 for heteromodal two-phase RF sensing according to aspects of the disclosure. In the example illustrated in FIG. 12, the first phase may be gNB-to-UE bistatic sensing and the second phase may be UE-to-gNB bistatic sensing. In the example shown in FIG. 12, at block 1210, a first phase gNB-to-UE bistatic sensing is performed. In some aspects, an optional step 1220 may determine whether or not a target has been detected; if so, at block 1230, the second phase UE-to-gNB bistatic sensing is performed, and if not, the second phase sensing step is skipped. Alternatively, the optional block 1220 is not performed, in which case the first phase sensing step at block 1210 is always followed by the second phase sensing step at block 1230.

Regarding the first phase gNB-to-UE bistatic sensing (block 1210), in some aspects, the network transmits at least one downlink sensing signal for use by the UE to perform bistatic sensing—this is the first phase (or scan phase) sensing. In some aspects, the first phase sensing signal can be a broadcast signal. In some aspects, the first phase sensing signal can be a periodic signal. In some aspects, the first phase sensing signal can be UE-specifically configured/allocated based on a request from the UE or from a sensing server.

During the second phase UE-to-gNB bistatic sensing (block 1230), the UE transmits at least one uplink sensing signal. In some aspects, the uplink sensing signal or signals transmitted by the UE may be based on the results of the first phase bistatic sensing. In some aspects, the UE may identify at least beam(s)/resource(s) to be used in the second phase UL sensing signal transmission, based on the first phase sensing signal sent by the gNB. In some aspects, the UE may request UL resources for the second phase sensing signal transmission after performing first phase sensing. In some aspects, the UE may report to the network the beam/resource index of downlink sensing signal, which could be the beam/resource that is quasi-co-located (QCL) with the uplink sensing signal.

In some aspects, the second phase sensing signal resource (in uplink) may be periodically configured by network. In some aspects, the UE may send a request to network, after sensing the first phase signal, for cancelling one or more of the second phase sensing signal resources. For example, a second phase sensing resource may not be used if there is no need to transmit sensing signal in that resource, such as when no target was detected in that beam direction during the first phase sensing.

In some aspects, the UE may report to the network the UE's capability for processing the first phase sensing prior to transmitting the second phase sensing. For example, if the second phase resources in uplink are periodically configured, then the UE may report its processing capability to network, where the capability indicates or implies a time duration between first phase sensing signal and second phase sensing signal and/or the time duration is for the UE to process first phase sensing signal received from gNB. In some aspects, the time duration can be expressed in absolute time unit, e.g., milliseconds, or in number of OFDM symbols or slots.

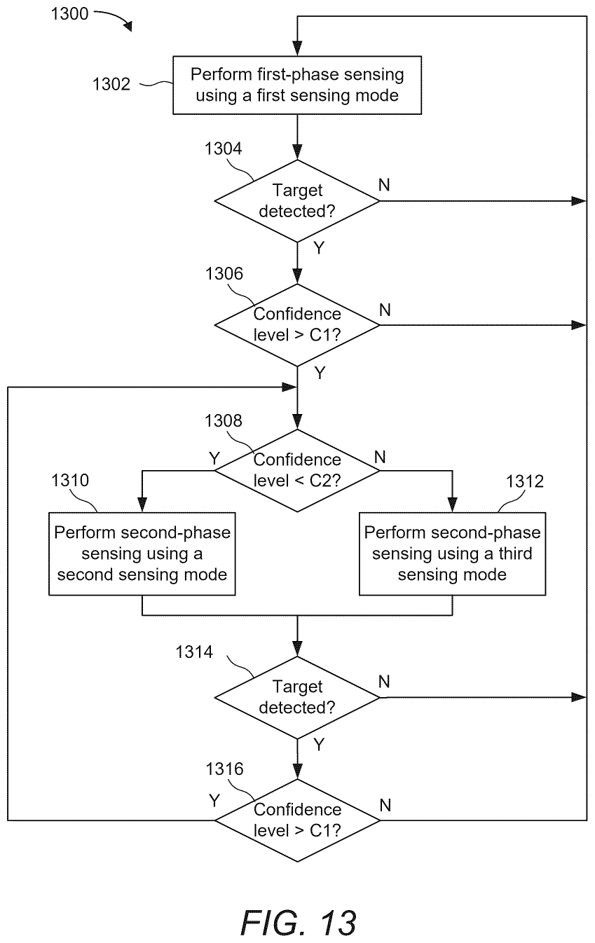

FIG. 13 is a flow chart illustrating a method 1300 for dynamic heteromodal two-phase RF sensing according to aspects of the disclosure. In some aspects, when a first type of sensing (referred to herein as “first-phase sensing”) detects targets with some confidence level, a second type of sensing (referred to herein as “second-phase sensing”) will be performed instead of first-phase sensing, and when second-phase sensing does not detect targets with some confidence level, then first-phase sensing will be performed instead of second-phase sensing.

In the example illustrated in FIG. 13, at block 1302, a first phase sensing operation using a first sensing mode is performed. In some aspects, when the first phase sensing detects targets with some confidence level, a second phase sensing will be triggered. In some aspects, the RRC may pre-define some resource for the second phase sensing, which could be activated/deactivated by downlink control information (DCI), sidelink control information (SCI), medium access control (MAC) control element (MAC-CE), or other mechanism.

In the example shown in FIG. 13, at block 1304, if no potential target is detected, the process returns to first phase sensing (block 1302). If a potential target is detected at block 1304, then at block 1306, it is determined whether the target detection exceeds a minimum confidence level C1: if not, the process returns to first phase sensing. If a potential target is detected with a confidence level that exceeds C1, then at block 1308, it is determined whether the confidence level exceeds C2, where in this example, C2>C1. If, at block 1308, the confidence level exceeds C2, then at block 1310, a second phase sensing is performed using a second sensing mode that is different from the first sensing mode. If, at block 1308, the confidence level exceeds C1 but does not exceed C2, then at block 1312, a second phase sensing is performed using a third sensing mode that is different from either the first sensing mode or the second sensing mode. In the example illustrated in FIG. 13, one first phase sensing mode and two possible second phase sensing modes are supported, but this example is illustrative and not limiting. For example, in other aspects, only one second phase sensing mode will be used (i.e., if the target confidence level exceeds C1). In yet other aspects, more than two different second phase sensing modes may be selected from, based on a corresponding number of confidence levels.

In the example shown in FIG. 13, at block 1314, it is determined if the second phase sensing detected a potential target: if a potential target is not detected, the process may fall back to first phase sensing (block 1302). If, at block 1314, a potential target is detected, then at block 1316 it is determined whether the target detection exceeds the minimum confidence level C1. If so, the process may repeat the second phase sensing, e.g., starting from block 1308; if not, the process may fall back to first phase sensing (block 1302). For example, a target may move out of the coverage of the sensing nodes between its detection at first phase sensing operation and performance of the second phase sensing operation. The second phase sensing mode may not detect or track the target later due to low signal-to-noise ratio (SNR) at the time of the second phase sensing mode operation.

In some aspects, when a fallback to first phase sensing occurs, the sensing entity should notify the transmitting entity directly or via the network. There are several options for fallback indication. For example, in some aspects the second phase sensing nodes (e.g., the gNB in UE-to-gNB bistatic sensing or the UE in gNB-to-UE bistatic sensing) may explicitly indicate that there was no target detected above some confidence level. In some aspects, the second phase sensing nodes may request cancellation of the second phase sensing transmission or reception resources. In some aspects, a failure of the sensing node to report the result of the second phase sensing results (e.g., within some time window) may be taken as an indication that during the second phase sensing, no targets were detected or that none with detected with a sufficient confidence level.

In some aspects, in the second phase sensing, there are be multiple resource configurations. In some aspects, the network may dynamically switch between the multiple resource configurations based on the sensing performance, e.g., with respect to a target SNR requirement. In some aspects, RRC may be used to pre-define the multiple resource patterns and/or configurations, which could be dynamically triggered and/or switched through DCI, MAC-CE, etc.

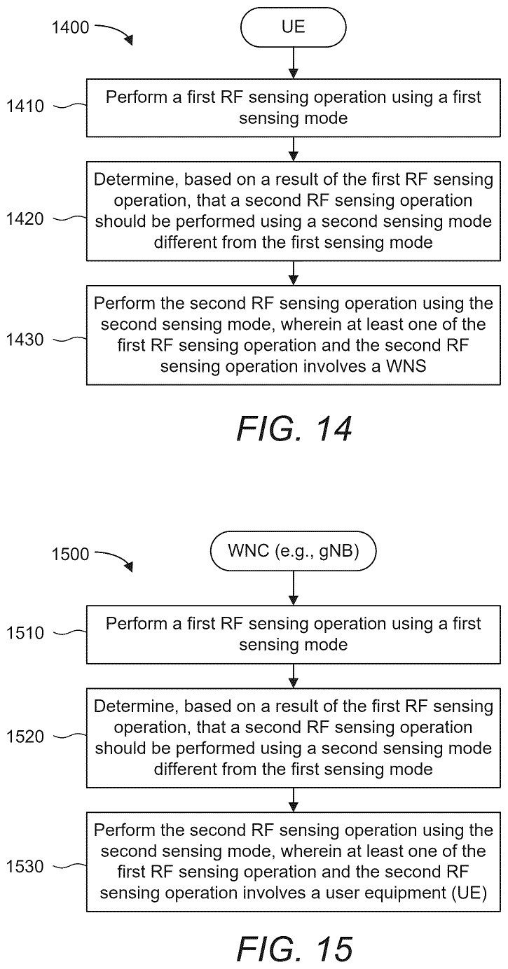

FIG. 14 is a flowchart of an example process 1400 associated with heteromodal two-phase RF sensing, according to aspects of the disclosure. In some implementations, one or more process blocks of FIG. 14 may be performed by a user equipment (UE) (e.g., UE 104). In some implementations, one or more process blocks of FIG. 14 may be performed by another device or a group of devices separate from or including the UE. Additionally, or alternatively, one or more process blocks of FIG. 14 may be performed by one or more components of UE 302, such as processor(s) 342, memory 340, WWAN transceiver(s) 310, short-range wireless transceiver(s) 320, satellite signal receiver 330, sensor(s) 344, user interface 346, and sensing control module(s) 348, any or all of which may be means for performing the operations of process 1400.

As shown in FIG. 14, process 1400 may include, at block 1410, performing a first RF sensing operation using a first sensing mode. Means for performing the operation of block 1410 may include the processor(s) 342, memory 340, or WWAN transceiver(s) 310 of the UE 302. For example, the UE 302 may perform the first RF sensing operation using the transceiver(s) 310 and the processor(s) 342.

As further shown in FIG. 14, process 1400 may include, at block 1420, determining, based on a result of the first RF sensing operation, that a second RF sensing operation should be performed using a second sensing mode different from the first sensing mode. Means for performing the operation of block 1420 may include 332 the processor(s) 342, memory 340, or WWAN transceiver(s) 310 of the UE 302. For example, the UE 302 may make the determination using the processor(s) 342.

As further shown in FIG. 14, process 1400 may include, at block 1430, performing the second RF sensing operation using the second sensing mode different from the first sensing mode, wherein at least one of the first RF sensing operation and the second RF sensing operation involves a wireless network structure (WNS). Means for performing the operation of block 1430 may include the processor(s) 342, memory 340, or WWAN transceiver(s) 310 of the UE 302. For example, the UE 302 may perform the second RF sensing operation using the transceiver(s) 310 and the processor(s) 342.

In some aspects, process 1400 includes reporting, to the WNS, the result of the first RF sensing operation, requesting, from the WNS, resources to be used by the UE for the second RF sensing operation, or a combination thereof, and receiving, from the WNS, information regarding the second sensing mode, comprising information identifying the second sensing mode, information indicating resources to be used by the UE for the second RF sensing operation, or a combination thereof.

In some aspects, reporting the result of the first RF sensing operation comprises reporting at least one of a direction, beam, or beam index of a potential target, a distance or signal delay value of a potential target, or a speed or doppler delay value of a potential target.

In some aspects, process 1400 includes receiving, from the WNS, information regarding the second sensing mode, comprising information identifying the second sensing mode, information indicating resources to be used by the UE for the second RF sensing operation, or a combination thereof.

In some aspects, determining, based on a result of the first RF sensing operation, that a second RF sensing operation should be performed using a second sensing mode different from the first sensing mode comprises determining that the first RF sensing operation detected a potential sensing target or detected a potential sensing target with a sensing confidence level that meets a sensing confidence threshold, sending, to the WNS, a request for resources to be used by the UE for the second RF sensing operation, and receiving, from the WNS, information indicating the resources to be used by the UE for the second RF sensing operation.

In some aspects, the first sensing mode comprises a UE-based monostatic sensing mode that comprises transmitting a sensing signal and listening for reflections of the sensing signal.

In some aspects, transmitting the sensing signal comprises transmitting the sensing signal on a licensed frequency band or on an unlicensed frequency band.

In some aspects, the second sensing mode comprises a UE-to-WNS bistatic sensing mode that comprises transmitting at least one uplink or sidelink sensing signal.

In some aspects, the second sensing mode comprises a WNS-to-UE bistatic sensing mode that comprises listening for reflections of a downlink sensing signal that is transmitted by the WNS.

In some aspects, the first sensing mode comprises a UE-to-WNS bistatic sensing mode that comprises transmitting at least one uplink or sidelink sensing signal.

In some aspects, the second sensing mode comprises a WNS-to-UE bistatic sensing mode that comprises listening for reflections of a downlink sensing signal that is transmitted by the WNS.

In some aspects, the first sensing mode comprises a WNS-to-UE bistatic sensing mode that comprises listening for reflections of a downlink sensing signal that is transmitted by the WNS.

In some aspects, the second sensing mode comprises a UE-to-WNS bistatic sensing mode that comprises transmitting at least one uplink or sidelink sensing signal.

Process 1400 may include additional implementations, such as any single implementation or any combination of implementations described below and/or in connection with one or more other processes described elsewhere herein. Although FIG. 14 shows example blocks of process 1400, in some implementations, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a flowchart of an example process 1500 associated with heteromodal two-phase RF sensing, according to aspects of the disclosure. In some implementations, one or more process blocks of FIG. 15 may be performed by a wireless network structure (WNS) (e.g., base station 304, gNB 222). In some implementations, one or more process blocks of FIG. 15 may be performed by another device or a group of devices separate from or including the WNS. Additionally, or alternatively, one or more process blocks of FIG. 15 may be performed by one or more components of an apparatus, such as a processor(s), memory, or transceiver(s), any or all of which may be means for performing the operations of process 1500.

As shown in FIG. 15, process 1500 may include, at block 1510, performing a first RF sensing operation using a first sensing mode. Means for performing the operation of block 1510 may include the processor(s), memory, or transceiver(s) of any of the apparatuses described herein. For example, the WNS may perform the first RF sensing operation using the transceiver(s) 350 and the processor(s) 384.

As further shown in FIG. 15, process 1500 may include, at block 1520, determining, based on a result of the first RF sensing operation, that a second RF sensing operation should be performed using a second sensing mode different from the first sensing mode. Means for performing the operation of block 1520 may include the processor(s), memory, or transceiver(s) of any of the apparatuses described herein. For example, the WNS may make this determination using the processor(s) 384.

As further shown in FIG. 15, process 1500 may include, at block 1530, performing the second RF sensing operation using the second sensing mode, wherein at least one of the first RF sensing operation and the second RF sensing operation involves a user equipment (UE). Means for performing the operation of block 1530 may include the processor(s), memory, or transceiver(s) of any of the apparatuses described herein. For example, the WNS may perform the second RF sensing operation using the transceiver(s) 350 and the processor(s) 384.

In some aspects, determining, based on a result of the first RF sensing operation, that a second RF sensing operation should be performed using a second sensing mode different from the first sensing mode comprises receiving, from the UE, the result of the first RF sensing operation, a request for resources to be used by the UE for the second RF sensing operation, or a combination thereof, determining, based on the result of the first RF sensing operation, the second sensing mode, resources to be used by the UE for these second RF sensing operation, or a combination thereof, and sending, to the UE, information indicating the second sensing mode, the resources to be used by the UE for the second RF sensing operation, or a combination thereof.

In some aspects, receiving the result of the first RF sensing operation comprises receiving at least one of a direction, beam, or beam index of a potential target, a distance or signal delay value of a potential target, or a speed or doppler delay value of a potential target.

In some aspects, performing a first RF sensing operation using a first sensing mode comprises configuring the UE to perform a UE-based monostatic sensing mode in which the UE transmits a sensing signal and listens for reflections of the sensing signal.

In some aspects, configuring the UE to perform the UE-based monostatic sensing mode comprises configuring the UE to transmit the sensing signal on a licensed frequency band or on an unlicensed frequency band.

In some aspects, the second sensing mode comprises a WNS-to-UE bistatic sensing mode that comprises transmitting at least one downlink sensing signal.

In some aspects, the second sensing mode comprises a UE-to-WNS bistatic sensing mode that comprises listening for reflections of an uplink or sidelink sensing signal that is transmitted by the UE.

In some aspects, the first sensing mode comprises a UE-to-WNS bistatic sensing mode that comprises listening for reflections of an uplink or sidelink sensing signal that is sent from the UE.

In some aspects, the second sensing mode comprises a WNS-to-UE bistatic sensing mode that comprises transmitting at least one downlink sensing signal.

In some aspects, the first sensing mode comprises a WNS-to-UE bistatic sensing mode that comprises transmitting at least one downlink sensing signal.

In some aspects, the second sensing mode comprises a UE-to-WNS bistatic sensing mode that comprises listening for reflections of an uplink or sidelink sensing signal that is transmitted by the UE.

Process 1500 may include additional implementations, such as any single implementation or any combination of implementations described below and/or in connection with one or more other processes described elsewhere herein.

Although FIG. 15 shows example blocks of process 1500, in some implementations, process 1500 may include additional blocks, fewer blocks, different blocks, or differently arranged blocks than those depicted in FIG. 15. Additionally, or alternatively, two or more of the blocks of process 1500 may be performed in parallel.

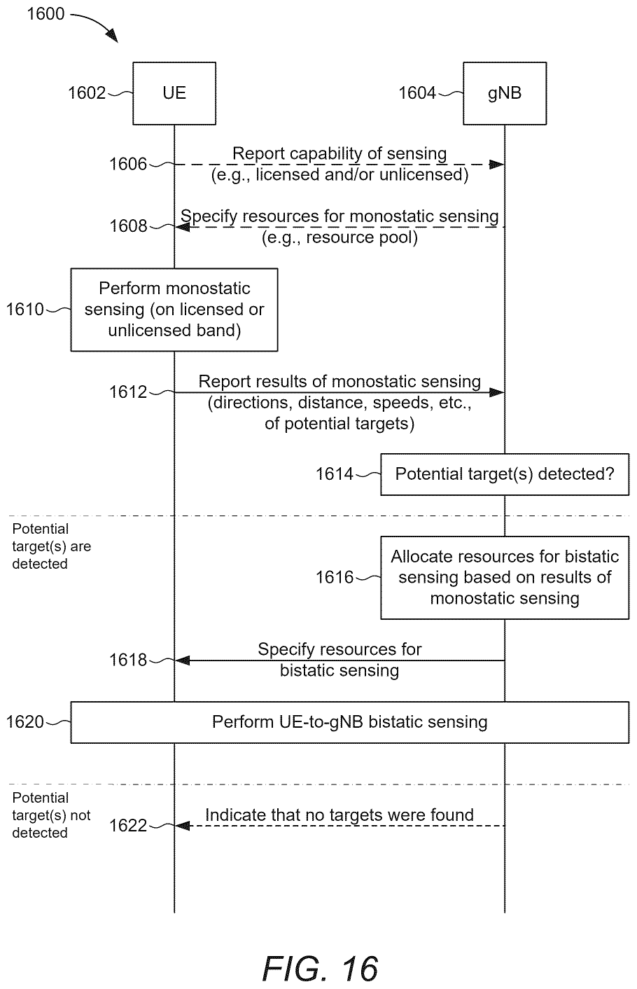

FIG. 16 is a signaling and event diagram illustrating a portion of an example process 1600 associated with heteromodal two-phase RF sensing, according to aspects of the disclosure. FIG. 16 illustrates an interaction between a UE 1602 and a gNB 1604. In the example illustrated in FIG. 16, the first phase is UE-based monostatic sensing and the second phase is UE-to-gNB bistatic sensing.

With optional signal 1606, the UE 1602 may report its capability for sensing to the gNB 1604. This step may be omitted if the UE 1602 has previously reported its capability to the gNB 1604.

With optional signal 1608, the gNB 1604 may specify which resources the UE 1602 should use for monostatic sensing in the first phase. This step may be omitted, for example, if the UE 1602 will perform monostatic sensing on an unlicensed band and can select its own resources for that use without input from the gNB 1604, or if the UE 1602 has previously received this information from the gNB 1604.

At block 1610, the UE 1602 performs monostatic sensing, which may be in an unlicensed band or a licensed band, e.g., as described for block 1012 above.

With signal 1612, the UE 1602 reports the results of monostatic sensing to the gNB 1604. In some aspects, the UE 1602 may provide the gNB 1604 with information including, but not limited to, beam directions for potential targets, coarse distance estimates for potential targets, and/or coarse speeds for potential targets.

At block 1614, the gNB 1604 determines whether or not one or more potential targets were detected by the monostatic sensing.

If, at block 1614, the gNB 1604 determines that one or more potential targets were detected by the monostatic sensing, then at block 1616 the gNB 1604 allocates resources to be used by the UE during UE-to-gNB bistatic sensing.

In some aspects, the gNB 1604 may configure only the subset of beams that have been reported by the UE 1602 as pertaining to potential targets, e.g., to avoid wasting time and resources performing RF sensing in directions that are not likely to have any targets. Thus, the resources allocated for the second phase are based on the sensing results from the first phase.

With signal 1618, the gNB 1604 specifies those resources to the UE 1602; and at block 1620, the UE 1602 and the gNB 1604 perform UE-to-gNB bistatic sensing, i.e., where the gNB 1604 measures the reflections of the signals transmitted by the UE 1602.

If, at block 1614, the gNB 1604 determines that no potential target was detected by the monostatic sensing, then the gNB 1604 may send optional signal 1622 to affirmatively notify the UE 1602 that no targets were found, or the gNB 1604 may simply do nothing, i.e., it takes no action to configure the UE 1602 for a bistatic sensing operation, from which the UE 1602 may infer that no targets were found during the monostatic sensing. Thus, in aspects where the monostatic sensing is performed in an unlicensed band, overhead in the network may be incurred only if one or more potential targets has been detected in the first phase.

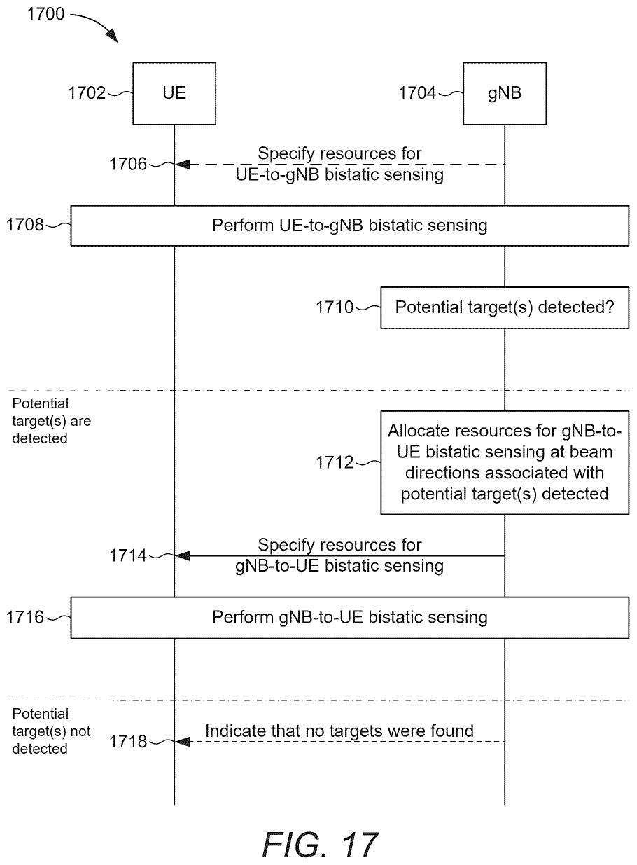

FIG. 17 is a signaling and event diagram illustrating a portion of an example process 1700 associated with heteromodal two-phase RF sensing, according to aspects of the disclosure. FIG. 17 illustrates an interaction between a UE 1702 and a gNB 1704. In the example illustrated in FIG. 17, the first phase is UE-to-gNB bistatic sensing and the second phase is gNB-to-UE bistatic sensing. In some aspects, the first phase is coarse sensing and the second phase is fine sensing.

With optional signal 1706, the gNB 1704 may specify which resources the UE 1702 should use for UE-to-gNB bistatic sensing. This step may be omitted if the UE 1702 has already been configured for UE-to-gNB bistatic sensing.

At block 1708, the UE 1702 and the gNB 1704 perform UE-to-gNB bistatic sensing, i.e., where the gNB 1704 measures the reflections of the signals transmitted by the UE 1702.

At block 1710, the gNB 1704 determines whether or not one or more potential targets were detected by the UE-to-gNB bistatic sensing.

If, at block 1710, the gNB 1704 determines that one or more potential targets were detected by the UE-to-gNB bistatic sensing, then at block 1712 the gNB 1704 allocates resources to be used by the UE during gNB-to-UE bistatic sensing. In some aspects, the second, fine sensing phase may limited to using beam directions identified during the first, coarse sensing phase as being of interest, e.g., as beam directions in which a potential target was detected.

With signal 1714, the gNB 1704 specifies those resources to the UE 1702. In some aspects, the gNB 1704 may specify the index or indices of first phase sensing signal beam(s) and/or resource(s) that are relevant for second phase sensing signal receiving at the UE 1702. This implies beam directions that the UE 1702 should use for sensing received signals during the second phase of sensing, e.g., due to the beams being quasi-co-located (QCL). In some aspects, each of the second phase sensing beams and/or resources may be individually configured if individual configuration is supported, or may be configured as a group if individual configuration is not supported.

At block 1716, the UE 1702 and the gNB 1704 perform gNB-to-UE bistatic sensing, i.e., where the UE 1702 measures the reflections of the signals transmitted by the gNB 1704. For example, the UE 1702 may have sent four sensing beams during the first phase of sensing, and the gNB 1704 may have determined that there are potential targets in only the first and last beams of the four beams, and indicates this to the UE 1702. Then, during the second sensing phase, the UE 1702 may then expect to receive two sensing beams from the gNB 1704 using the same spatial filters as the UE 1702 used to transmit the first and last beams during the first sensing phase.

If, at block 1710, the gNB 1704 determines that no potential target was detected by the UE-to-gNB bistatic sensing, then the gNB 1704 may send optional signal 1718 to affirmatively notify the UE 1702 that no targets were found, or the gNB 1704 may simply do nothing, i.e., it takes no action to configure the UE 1702 for a gNB-to-UE bistatic sensing operation, from which the UE 1702 may infer that no targets were found during the UE-to-gNB bistatic sensing. This approach requires minimal feedback and/or incurs minimal report overhead for coupling the two sensing phases.

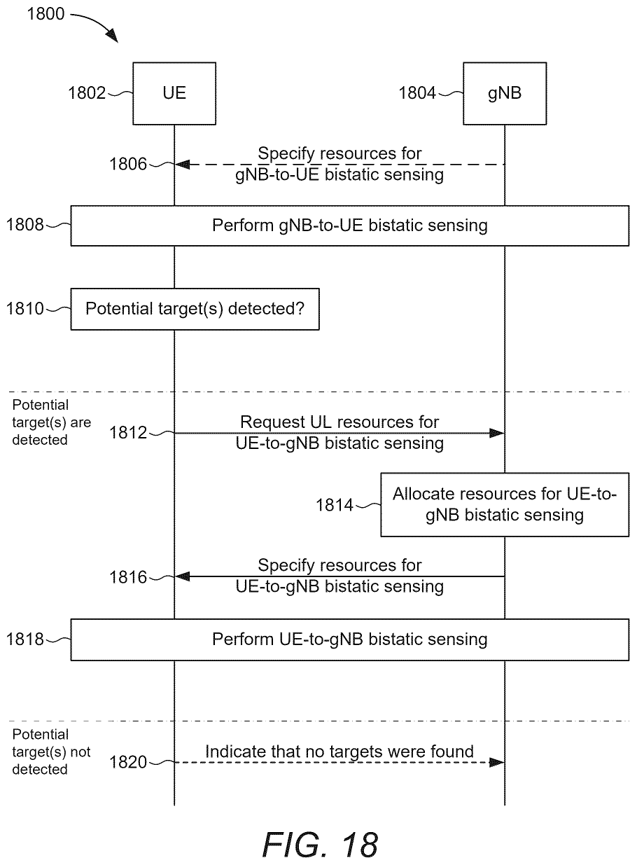

FIG. 18 is a signaling and event diagram illustrating a portion of an example process 1800 associated with heteromodal two-phase RF sensing, according to aspects of the disclosure. FIG. 18 illustrates an interaction between a UE 1802 and a gNB 1804. In the example illustrated in FIG. 17, the first phase is gNB-to-UE bistatic sensing and the second phase is UE-to-gNB bistatic sensing. In some aspects, the first phase may be referred to as a scan phase, and the second phase may be referred to as a measurement phase.

With optional signal 1806, the gNB 1804 may specify which resources the UE 1802 should use for gNB-to-UE sensing. This step may be omitted if the UE 1802 has previously received this information from the gNB 1804.

At block 1808, the UE 1802 and the gNB 1804 perform gNB-to-UE bistatic sensing, e.g., where the UE 1802 measures reflections of signals transmitted by the gNB 1804. For example, during the first phase, the gNB 1804 may transmit DL sensing signals for the UE 1802 to use when performing bistatic sensing. In some aspects, the first phase sensing signals may be broadcast and/or periodic signals. In some aspects, the first phase sensing signals may be UE-specifically configured and/or allocated, e.g., based on a request from the UE 1802 or from a sensing server within the network.

At block 1810, the UE 1802 determines whether or not one or more potential targets were detected by the gNB-to-UE.

If, at block 1810, the UE 1802 determines that one or more potential targets were detected by the monostatic sensing, then with signal 1812 the UE 1802 requests resources to be used by the UE during UE-to-gNB bistatic sensing. In some aspects, the UE 1802 may identify the beam(s) and/or resource(s) to be used in the second phase UL sensing signal transmission, based on the first phase sensing signal sent by gNB 1804. In some aspects, the UE 1802 may request UL resources pertaining only to beam directions in which potential targets have been detected. Other information that the UE 1802 may provide to the gNB 1804 includes, but is not limited to, the number of beams (or resources) that the UE 1802 can support; the UE's beamforming capability (number of antenna elements, beam width, etc.); a frequency comb configuration for second phase sensing signal transmission (e.g., which may be determined based on a target range identified during the first sensing phase); a bandwidth of a sensing signal transmission (e.g., which may be based on a sensing requirement); or a sensing signal time spacing, or “time comb” (e.g., which may be needed if velocity estimation for the target is needed). Where the second phase resources in UL are periodically configured, in some aspects the UE 1802 may report its processing capability to the network, where the processing capability indicates or implies a time duration between first phase sensing signal and second phase sensing required by the UE 1802 to process first phase sensing signal received from gNB 1804. In some aspects, this time duration can be expressed in absolute time units (e.g., milliseconds), in OFDM symbols, in slots, etc.

Alternatively, the second phase sensing signal resource in UL may be periodically configured by the network, in which case the signal 1812 may comprise a request to cancel one or more of the second phase sensing resources, e.g., because no target was detected by the UE 1802 in that beam direction during the first phase of sensing.

At block 1814, the gNB 1804 allocates resources for UE-to-gNB bistatic sensing. In some aspects, the resources allocated are based on the information provided to the gNB 1804 in signal 1812. With signal 1816, the gNB 1804 specifies those resources to the UE 1802. At block 1818, the UE 1802 and the gNB 1804 perform UE-to-gNB bistatic sensing, i.e., where the gNB 1804 measures the reflections of the signals transmitted by the UE 1802.

If, at block 1810, the UE 1802 determines that no potential target was detected by the monostatic sensing, then the UE 1802 may send optional signal 1820 to affirmatively notify the gNB 1804 that no targets were found, or the UE 1802 may simply do nothing, from which the gNB 1804 may infer that no targets were found during the UE-to-gNB bistatic sensing.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless sensing performed by a user equipment (UE), the method comprising: performing a first radio frequency (RF) sensing operation using a first sensing mode; determining, based on a result of the first RF sensing operation, that a second RF sensing operation should be performed using a second sensing mode different from the first sensing mode; and performing the second RF sensing operation using the second sensing mode, wherein at least one of the first RF sensing operation or the second RF sensing operation involves a wireless network structure (WNS).

Clause 2. The method of clause 1 wherein determining, based on a result of the first RF sensing operation, that a second RF sensing operation should be performed using a second sensing mode different from the first sensing mode comprises: reporting, to the WNS, the result of the first RF sensing operation, requesting, from the WNS, resources to be used by the UE for the second RF sensing operation, or a combination thereof; and receiving, from the WNS, information regarding the second sensing mode, comprising information identifying the second sensing mode, information indicating resources to be used by the UE for the second RF sensing operation, or a combination thereof.

Clause 3. The method of clause 2, wherein reporting the result of the first RF sensing operation comprises reporting at least one of: a direction, beam, or beam index of a potential target; a distance or signal delay value of a potential target; or a speed or doppler delay value of a potential target.

Clause 4. The method of any of clauses 1 to 3 wherein determining, based on a result of the first RF sensing operation, that a second RF sensing operation should be performed using a second sensing mode different from the first sensing mode comprises: receiving, from the WNS, information regarding the second sensing mode, comprising information identifying the second sensing mode, information indicating resources to be used by the UE for the second RF sensing operation, or a combination thereof.

Clause 5. The method of any of clauses 1 to 4, wherein determining, based on a result of the first RF sensing operation, that a second RF sensing operation should be performed using a second sensing mode different from the first sensing mode comprises: determining that the first RF sensing operation detected a potential sensing target or detected a potential sensing target with a sensing confidence level that meets a sensing confidence threshold; sending, to the WNS, a request for resources to be used by the UE for the second RF sensing operation; and receiving, from the WNS, information indicating the resources to be used by the UE for the second RF sensing operation.

Clause 6. The method of any of clauses 1 to 5, wherein the first sensing mode comprises a UE-based monostatic sensing mode that comprises transmitting a sensing signal and listening for reflections of the sensing signal.

Clause 7. The method of clause 6, wherein transmitting the sensing signal comprises transmitting the sensing signal on a licensed frequency band or on an unlicensed frequency band.

Clause 8. The method of any of clauses 6 to 7, wherein the second sensing mode comprises a UE-to-WNS bistatic sensing mode that comprises transmitting at least one uplink or sidelink sensing signal.

Clause 9. The method of any of clauses 6 to 8, wherein the second sensing mode comprises a WNS-to-UE bistatic sensing mode that comprises listening for reflections of a downlink sensing signal that is transmitted by the WNS.

Clause 10. The method of any of clauses 1 to 9, wherein the first sensing mode comprises a UE-to-WNS bistatic sensing mode that comprises transmitting at least one uplink or sidelink sensing signal.

Clause 11. The method of clause 10, wherein the second sensing mode comprises a WNS-to-UE bistatic sensing mode that comprises listening for reflections of a downlink sensing signal that is transmitted by the WNS.

Clause 12. The method of any of clauses 1 to 11, wherein the first sensing mode comprises a WNS-to-UE bistatic sensing mode that comprises listening for reflections of a downlink sensing signal that is transmitted by the WNS.

Clause 13. The method of any of clauses 10 to 12, wherein the second sensing mode comprises a UE-to-WNS bistatic sensing mode that comprises transmitting at least one uplink or sidelink sensing signal.

Clause 14. A method of wireless sensing performed by a wireless network structure (WNS), the method comprising: performing a first radio frequency (RF) sensing operation using a first sensing mode; determining, based on a result of the first RF sensing operation, that a second RF sensing operation should be performed using a second sensing mode different from the first sensing mode; and performing a second RF sensing operation using a second sensing mode different from the first sensing mode, wherein at least one of the first sensing mode and the second sensing mode involves a user equipment (UE).

Clause 15. The method of clause 14, wherein determining, based on a result of the first RF sensing operation, that a second RF sensing operation should be performed using a second sensing mode different from the first sensing mode comprises: receiving, from the UE, the result of the first RF sensing operation, a request for resources to be used by the UE for the second RF sensing operation, or a combination thereof; determining, based on the result of the first RF sensing operation, the second sensing mode, resources to be used by the UE for these second RF sensing operation, or a combination thereof; and sending, to the UE, information indicating the second sensing mode, the resources to be used by the UE for the second RF sensing operation, or a combination thereof.

Clause 16. The method of clause 15, wherein receiving the result of the first RF sensing operation comprises receiving at least one of: a direction, beam, or beam index of a potential target; a distance or signal delay value of a potential target; or a speed or doppler delay value of a potential target.

Clause 17. The method of any of clauses 14 to 16, wherein performing a first RF sensing operation using a first sensing mode comprises configuring the UE to perform a UE-based monostatic sensing mode in which the UE transmits a sensing signal and listens for reflections of the sensing signal.

Clause 18. The method of clause 17, wherein configuring the UE to perform the UE-based monostatic sensing mode comprises configuring the UE to transmit the sensing signal on a licensed frequency band or on an unlicensed frequency band.

Clause 19. The method of any of clauses 17 to 18, wherein the second sensing mode comprises a WNS-to-UE bistatic sensing mode that comprises transmitting at least one downlink sensing signal.

Clause 20. The method of any of clauses 17 to 19, wherein the second sensing mode comprises a UE-to-WNS bistatic sensing mode that comprises listening for reflections of an uplink or sidelink sensing signal that is transmitted by the UE.

Clause 21. The method of any of clauses 14 to 20, wherein the first sensing mode comprises a UE-to-WNS bistatic sensing mode that comprises listening for reflections of an uplink or sidelink sensing signal that is sent from the UE.

Clause 22. The method of clause 21, wherein the second sensing mode comprises a WNS-to-UE bistatic sensing mode that comprises transmitting at least one downlink sensing signal.

Clause 23. The method of any of clauses 14 to 22, wherein the first sensing mode comprises a WNS-to-UE bistatic sensing mode that comprises transmitting at least one downlink sensing signal.

Clause 24. The method of clause 23, wherein the second sensing mode comprises a UE-to-WNS bistatic sensing mode that comprises listening for reflections of an uplink or sidelink sensing signal that is transmitted by the UE.

Clause 25. A user equipment (UE), comprising: one or more memories; one or more transceivers; and one or more processors communicatively coupled to the one or more memories and the one or more transceivers, the one or more processors, either alone or in combination, configured to: perform a first radio frequency (RF) sensing operation using a first sensing mode; determine, based on a result of the first RF sensing operation, that a second RF sensing operation should be performed using a second sensing mode different from the first sensing mode; and perform the second RF sensing operation using the second sensing mode, wherein at least one of the first RF sensing operation or the second RF sensing operation involves a wireless network structure (WNS), and wherein at least one of the first sensing mode or the second sensing mode comprises a UE-based monostatic sensing mode, a UE-to-WNS bistatic sensing mode, or a WNS-to-UE bistatic sensing mode.

Clause 26. The UE of clause 25, wherein, to determine, based on a result of the first RF sensing operation, that the second RF sensing operation should be performed using the second sensing mode different from the first sensing mode, the one or more processors, either alone or in combination, are configured to: report, to the WNS, the result of the first RF sensing operation, request, from the WNS, resources to be used by the UE for the second RF sensing operation, or a combination thereof; and receive, from the WNS, information regarding the second sensing mode, comprising information identifying the second sensing mode, information indicating resources to be used by the UE for the second RF sensing operation, or a combination thereof.

Clause 27. The UE of any of clauses 25 to 26, wherein, to report the result of the first RF sensing operation, the one or more processors, either alone or in combination, are configured to report at least one of: a direction, beam, or beam index of a potential target; a distance or signal delay value of a potential target; or a speed or doppler delay value of a potential target.

Clause 28. A wireless network structure (WNS), comprising: one or more memories; one or more transceivers; and one or more processors communicatively coupled to the one or more memories and the one or more transceivers, the one or more processors, either alone or in combination, configured to: perform a first radio frequency (RF) sensing operation using a first sensing mode; determine, based on a result of the first RF sensing operation, that a second RF sensing operation should be performed using a second sensing mode different from the first sensing mode; and perform a second RF sensing operation using a second sensing mode different from the first sensing mode, wherein at least one of the first sensing mode and the second sensing mode involves a user equipment (UE), and wherein at least one of the first sensing mode or the second sensing mode comprises a UE-based monostatic sensing mode, a UE-to-WNS bistatic sensing mode, or a WNS-to-UE bistatic sensing mode.

Clause 29. The WNS of clause 28, wherein, to determine, based on a result of the first RF sensing operation, that a second RF sensing operation should be performed using a second sensing mode different from the first sensing mode, the one or more processors, either alone or in combination, are configured to: receive, from the UE, the result of the first RF sensing operation, a request for resources to be used by the UE for the second RF sensing operation, or a combination thereof; determine, based on the result of the first RF sensing operation, the second sensing mode, resources to be used by the UE for these second RF sensing operation, or a combination thereof; and send, to the UE, information indicating the second sensing mode, the resources to be used by the UE for the second RF sensing operation, or a combination thereof.

Clause 30. The WNS of clause 29, wherein, to receive the result of the first RF sensing operation, the one or more processors, either alone or in combination, are configured to receive at least one of: a direction, beam, or beam index of a potential target; a distance or signal delay value of a potential target; or a speed or doppler delay value of a potential target.

Clause 31. An apparatus comprising a memory, a transceiver, and a processor communicatively coupled to the memory and the transceiver, the memory, the transceiver, and the processor configured to perform a method according to any of clauses 1 to 24.

Clause 32. An apparatus comprising means for performing a method according to any of clauses 1 to 24.

Clause 33. A non-transitory computer-readable medium storing computer-executable instructions, the computer-executable comprising at least one instruction for causing a computer or processor to perform a method according to any of clauses 1 to 24.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless sensing performed by a user equipment (UE), the method comprising:
performing a first radio frequency (RF) sensing operation using a first sensing mode;
determining, based on a result of the first RF sensing operation, that a second RF sensing operation should be performed using a second sensing mode different from the first sensing mode; and
performing the second RF sensing operation using the second sensing mode,
wherein at least one of the first RF sensing operation or the second RF sensing operation involves a wireless network structure (WNS).

2. The method of claim 1, wherein determining, based on a result of the first RF sensing operation, that a second RF sensing operation should be performed using a second sensing mode different from the first sensing mode comprises:
reporting, to the WNS, the result of the first RF sensing operation, requesting, from the WNS, resources to be used by the UE for the second RF sensing operation, or a combination thereof; and
receiving, from the WNS, information regarding the second sensing mode, comprising information identifying the second sensing mode, information indicating resources to be used by the UE for the second RF sensing operation, or a combination thereof.

3. The method of claim 2, wherein reporting the result of the first RF sensing operation comprises reporting at least one of:
a direction, beam, or beam index of a potential target;
a distance or signal delay value of a potential target; or
a speed or doppler delay value of a potential target.

4. The method of claim 1, wherein determining, based on a result of the first RF sensing operation, that a second RF sensing operation should be performed using a second sensing mode different from the first sensing mode comprises:
receiving, from the WNS, information regarding the second sensing mode, comprising information identifying the second sensing mode, information indicating resources to be used by the UE for the second RF sensing operation, or a combination thereof.

5. The method of claim 1, wherein determining, based on a result of the first RF sensing operation, that a second RF sensing operation should be performed using a second sensing mode different from the first sensing mode comprises:
determining that the first RF sensing operation detected a potential sensing target or detected a potential sensing target with a sensing confidence level that meets a sensing confidence threshold;
sending, to the WNS, a request for resources to be used by the UE for the second RF sensing operation; and
receiving, from the WNS, information indicating the resources to be used by the UE for the second RF sensing operation.

6. The method of claim 1, wherein the first sensing mode comprises a UE-based monostatic sensing mode that comprises transmitting a sensing signal and listening for reflections of the sensing signal.

7. The method of claim 6, wherein transmitting the sensing signal comprises transmitting the sensing signal on a licensed frequency band or on an unlicensed frequency band.

8. The method of claim 6, wherein the second sensing mode comprises a UE-to-WNS bistatic sensing mode that comprises transmitting at least one uplink or sidelink sensing signal.

9. The method of claim 6, wherein the second sensing mode comprises a WNS-to-UE bistatic sensing mode that comprises listening for reflections of a downlink sensing signal that is transmitted by the WNS.

10. The method of claim 1, wherein the first sensing mode comprises a UE-to-WNS bistatic sensing mode that comprises transmitting at least one uplink or sidelink sensing signal.

11. The method of claim 10, wherein the second sensing mode comprises a WNS-to-UE bistatic sensing mode that comprises listening for reflections of a downlink sensing signal that is transmitted by the WNS.

12. The method of claim 1, wherein the first sensing mode comprises a WNS-to-UE bistatic sensing mode that comprises listening for reflections of a downlink sensing signal that is transmitted by the WNS.

13. The method of claim 10, wherein the second sensing mode comprises a UE-to-WNS bistatic sensing mode that comprises transmitting at least one uplink or sidelink sensing signal.

14. A method of wireless sensing performed by a wireless network structure (WNS), the method comprising:
performing a first radio frequency (RF) sensing operation using a first sensing mode;
determining, based on a result of the first RF sensing operation, that a second RF sensing operation should be performed using a second sensing mode different from the first sensing mode; and
performing a second RF sensing operation using a second sensing mode different from the first sensing mode,
wherein at least one of the first sensing mode and the second sensing mode involves a user equipment (UE).

15. The method of claim 14, wherein determining, based on a result of the first RF sensing operation, that a second RF sensing operation should be performed using a second sensing mode different from the first sensing mode comprises:
receiving, from the UE, the result of the first RF sensing operation, a request for resources to be used by the UE for the second RF sensing operation, or a combination thereof;
determining, based on the result of the first RF sensing operation, the second sensing mode, resources to be used by the UE for these second RF sensing operation, or a combination thereof; and
sending, to the UE, information indicating the second sensing mode, the resources to be used by the UE for the second RF sensing operation, or a combination thereof.

16. The method of claim 15, wherein receiving the result of the first RF sensing operation comprises receiving at least one of:
a direction, beam, or beam index of a potential target;
a distance or signal delay value of a potential target; or
a speed or doppler delay value of a potential target.

17. The method of claim 14, wherein performing a first RF sensing operation using a first sensing mode comprises configuring the UE to perform a UE-based monostatic sensing mode in which the UE transmits a sensing signal and listens for reflections of the sensing signal.

18. The method of claim 17, wherein configuring the UE to perform the UE-based monostatic sensing mode comprises configuring the UE to transmit the sensing signal on a licensed frequency band or on an unlicensed frequency band.

19. The method of claim 17, wherein the second sensing mode comprises a WNS-to-UE bistatic sensing mode that comprises transmitting at least one downlink sensing signal.

20. The method of claim 17, wherein the second sensing mode comprises a UE-to-WNS bistatic sensing mode that comprises listening for reflections of an uplink or sidelink sensing signal that is transmitted by the UE.

21. The method of claim 14, wherein the first sensing mode comprises a UE-to-WNS bistatic sensing mode that comprises listening for reflections of an uplink or sidelink sensing signal that is sent from the UE.

22. The method of claim 21, wherein the second sensing mode comprises a WNS-to-UE bistatic sensing mode that comprises transmitting at least one downlink sensing signal.

23. The method of claim 14, wherein the first sensing mode comprises a WNS-to-UE bistatic sensing mode that comprises transmitting at least one downlink sensing signal.

24. The method of claim 23, wherein the second sensing mode comprises a UE-to-WNS bistatic sensing mode that comprises listening for reflections of an uplink or sidelink sensing signal that is transmitted by the UE.

25. A user equipment (UE), comprising:
one or more memories;
one or more transceivers; and
one or more processors communicatively coupled to the one or more memories and the one or more transceivers, the one or more processors, either alone or in combination, configured to:
perform a first radio frequency (RF) sensing operation using a first sensing mode;
determine, based on a result of the first RF sensing operation, that a second RF sensing operation should be performed using a second sensing mode different from the first sensing mode; and
perform the second RF sensing operation using the second sensing mode,
wherein at least one of the first RF sensing operation or the second RF sensing operation involves a wireless network structure (WNS), and wherein at least one of the first sensing mode or the second sensing mode comprises a UE-based monostatic sensing mode, a UE-to-WNS bistatic sensing mode, or a WNS-to-UE bistatic sensing mode.

26. The UE of claim 25, wherein, to determine, based on a result of the first RF sensing operation, that the second RF sensing operation should be performed using the second sensing mode different from the first sensing mode, the one or more processors, either alone or in combination, are configured to:
report, to the WNS, the result of the first RF sensing operation, request, from the WNS, resources to be used by the UE for the second RF sensing operation, or a combination thereof, and
receive, from the WNS, information regarding the second sensing mode, comprising information identifying the second sensing mode, information indicating resources to be used by the UE for the second RF sensing operation, or a combination thereof.

27. The UE of claim 25, wherein, to report the result of the first RF sensing operation, the one or more processors, either alone or in combination, are configured to report at least one of:
a direction, beam, or beam index of a potential target;
a distance or signal delay value of a potential target; or
a speed or doppler delay value of a potential target.

28. A wireless network structure (WNS), comprising:
one or more memories;
one or more transceivers; and
one or more processors communicatively coupled to the one or more memories and the one or more transceivers, the one or more processors, either alone or in combination, configured to:
perform a first radio frequency (RF) sensing operation using a first sensing mode;
determine, based on a result of the first RF sensing operation, that a second RF sensing operation should be performed using a second sensing mode different from the first sensing mode; and
perform a second RF sensing operation using a second sensing mode different from the first sensing mode,
wherein at least one of the first sensing mode and the second sensing mode involves a user equipment (UE), and wherein at least one of the first sensing mode or the second sensing mode comprises a UE-based monostatic sensing mode, a UE-to-WNS bistatic sensing mode, or a WNS-to-UE bistatic sensing mode.

29. The WNS of claim 28, wherein, to determine, based on a result of the first RF sensing operation, that a second RF sensing operation should be performed using a second sensing mode different from the first sensing mode, the one or more processors, either alone or in combination, are configured to:
receive, from the UE, the result of the first RF sensing operation, a request for resources to be used by the UE for the second RF sensing operation, or a combination thereof;
determine, based on the result of the first RF sensing operation, the second sensing mode, resources to be used by the UE for these second RF sensing operation, or a combination thereof; and
send, to the UE, information indicating the second sensing mode, the resources to be used by the UE for the second RF sensing operation, or a combination thereof.

30. The WNS of claim 29, wherein, to receive the result of the first RF sensing operation, the one or more processors, either alone or in combination, are configured to receive at least one of:
a direction, beam, or beam index of a potential target;
a distance or signal delay value of a potential target; or
a speed or doppler delay value of a potential target.
